(19) United States
(12) Patent Application Publication
(10) Pub. No.: US 2024/0403657 A1
(43) Pub. Date: Dec. 5, 2024

(54) RISK EVALUATION DEVICE, DATA PROTECTION DEVICE, AND RISK EVALUATION METHOD

(71) Applicant: NEC Corporation, Tokyo (JP)

(72) Inventors: Batnyam Enkhtaivan, Tokyo (JP); Isamu Teranishi, Tokyo (JP)

(73) Assignee: NEC Corporation, Tokyo (JP)

(21) Appl. No.: 18/677,962

(22) Filed: May 30, 2024

(30) Foreign Application Priority Data
Jun. 2, 2023 (JP) 2023-091920

(51) Int. Cl. G06N 5/01

(52) U.S. Cl. CPC G06N 5/01

(57) ABSTRACT

A risk evaluation device acquires target data including an explanatory variable value list and a target variable value, calculates a confidence score for each partial model of a target model, wherein the target model includes the partial model for each of a plurality of ways of performing the first class classification, and wherein the partial model indicates, for each class in a class classification performed using a combination of the first class classification and the second class classification, a degree to which an element of a second set generated for each partial model from a predetermined first set is classified into the class, and evaluates a possibility that the target data is included in the first set based on the confidence score of each partial model.

This application is based upon and claims the benefit of priority from Japanese patent application No. 2023-091920, filed on Jun. 2, 2023, the disclosure of which is incorporated herein in its entirety by reference.

### TECHNICAL FIELD

The present disclosure relates to a risk evaluation device, a data protection device, and a risk evaluation method.

### BACKGROUND ART

A model that includes a plurality of partial models, such as a random forest, is sometimes used. For example, Japanese Unexamined Patent Application, First Publication No. 2019-207604 describes that a model used when estimating the emotions of a person can be constructed using a random forest.

### SUMMARY

It is preferable to be able to evaluate the risk of information leakage when a model including a plurality of partial models is used.

An example object of the present disclosure is to provide a risk evaluation device, a data protection device, a risk evaluation method, and a non-transitory storage medium storing a program that are capable of solving the above problem.

According to a first example aspect of the present disclosure, a risk evaluation device acquires target data, which includes an explanatory variable value list, being a list of values of classification items representing items used in a first class classification, and a target variable value, being a value that identifies a class in a second class classification, calculates a confidence score for each class in a class classification performed using a combination of the first class classification and the second class classification that indicates, for each partial model of a model that includes each of a plurality of ways of performing the first class classification, the partial model indicating a degree to which an element of a second set that has been generated for each partial model from a predetermined first set is classified into the class, a degree to which the element of the second set is classified into a class in the first class classification, which is performed with respect to the explanatory variable value list included in the target data, and a class in the second class classification, which is identified by the target variable value included in the target data, and evaluates a possibility that the target data is included in the first set based on the confidence score of each partial model.

According to a second example aspect of the present disclosure, a data protection device acquires an explanatory variable value list, being a list of values of classification items representing items used in a first class classification, calculates a confidence score for each class in a class classification performed using a combination of the first class classification and the second class classification that indicates, for each partial model of a model that includes each of a plurality of ways of performing the first class classification, the partial model indicating a degree to which an element of a second set that has been generated for each partial model from a predetermined first set is classified into the class, a degree to which the element of the second set is classified into a class in the first class classification, which is performed with respect to the explanatory variable value list, and a class in the second class classification, in a case where the confidence score indicates that a number of elements in the second set that are classified into a certain class is 0, rewrites the confidence score so as to indicate that a number of elements in the second set that are classified into the class is 1 or more; and a confidence score output means that outputs a rewritten confidence score.

According to a third example aspect of the present disclosure, in a risk evaluation method, a computer performs the steps of: acquiring target data, which includes an explanatory variable value list, being a list of values of classification items representing items used in a first class classification, and a target variable value, being a value that identifies a class in a second class classification; calculating a confidence score for each class in a class classification performed using a combination of the first class classification and the second class classification that indicates, for each partial model of a model that includes each of a plurality of ways of performing the first class classification, the partial model indicating a degree to which an element of a second set that has been generated for each partial model from a predetermined first set is classified into the class, a degree to which the element of the second set is classified into a class in the first class classification, which is performed with respect to the explanatory variable value list included in the target data, and a class in the second class classification, which is identified by the target variable value included in the target data; and evaluating a possibility that the target data is included in the first set based on the confidence score of each partial model.

According to a fourth example aspect of the present disclosure, a non-transitory storage medium storing a program causes a computer to execute the steps of: acquiring target data, which includes an explanatory variable value list, being a list of values of classification items representing items used in a first class classification, and a target variable value, being a value that identifies a class in a second class classification; calculating a confidence score for each class in a class classification performed using a combination of the first class classification and the second class classification that indicates, for each partial model of a model that includes each of a plurality of ways of performing the first class classification, the partial model indicating a degree to which an element of a second set that has been generated for each partial model from a predetermined first set is classified into the class, a degree to which the element of the second set is classified into a class in the first class classification, which is performed with respect to the explanatory variable value list included in the target data, and a class in the second class classification, which is identified by the target variable value included in the target data; and evaluating a possibility that the target data is included in the first set based on the confidence score of each partial model.

According to the present disclosure, it is possible to evaluate the risk of information leakage when a model including a plurality of partial models is used.

### BRIEF DESCRIPTION OF THE DRAWINGS

FIG. 1 is a diagram showing an example of a configuration of a risk evaluation device according to a first example embodiment.

FIG. 2 is a diagram showing an example of a data structure of a data set used to generate a target model.

FIG. 3 is a diagram showing an example of a data structure of a candidate value list for “classification item i”.

FIG. 4 is a diagram showing a first example of a partial model.

FIG. 5 is a diagram showing a second example of a partial model.

FIG. 6 is a diagram showing a third example of a partial model.

FIG. 7 is a diagram showing an example of data input and output in an estimation using a target model.

FIG. 8 is a diagram showing an example of generating target data for estimating an unknown value of a classification item in the first example embodiment.

FIG. 9 is a diagram showing an example of the processing procedure performed by a risk evaluation device 100 when a risk evaluation unit generates a non-applicability score list according to the first example embodiment.

FIG. 10 is a diagram showing an example of the processing procedure performed by a risk evaluation device 100 when a risk evaluation unit generates an exclusion list according to the first example embodiment.

FIG. 11 is a diagram showing an example of a configuration of a risk evaluation device according to a second example embodiment.

FIG. 12 is a diagram showing a first example of the processing procedure performed by a risk evaluation device 200 when an estimation unit estimates the value of a classification item according to the second example embodiment.

FIG. 13 is a diagram showing a second example of the processing procedure performed by a risk evaluation device 200 when an estimation unit estimates the value of a classification item according to the second example embodiment.

FIG. 14 is a diagram showing a third example of the processing procedure performed by a risk evaluation device 200 when an estimation unit estimates the value of a classification item according to the second example embodiment.

FIG. 15 is a diagram showing a fourth example of the processing procedure performed by a risk evaluation device 200 when an estimation unit estimates the value of a classification item according to the second example embodiment.

FIG. 16 is a diagram showing a fifth example of the processing procedure performed by a risk evaluation device 200 when an estimation unit estimates the value of a classification item according to the second example embodiment.

FIG. 17 is a diagram showing an example of a configuration of a data protection device according to a third example embodiment.

FIG. 18 is a diagram showing an example of the processing procedure performed when the data protection device according to the third example embodiment acquires an explanatory variable value list and outputs a confidence score.

FIG. 19 is a diagram showing an example of a configuration of a risk evaluation device according to a fourth example embodiment.

FIG. 20 is a diagram showing an example of a configuration of a data protection device according to a fifth example embodiment.

FIG. 21 is a diagram showing an example of the processing procedure of a risk evaluation method according to a sixth example embodiment.

FIG. 22 is a diagram showing an example of the processing procedure of a data protection method according to a seventh example embodiment.

FIG. 23 is a schematic block diagram showing a configuration of a computer according to at least one example embodiment.

### EXAMPLE EMBODIMENT

Hereunder, example embodiments of the present embodiment will be described. However, the following example embodiments do not limit the disclosure according to the claims. Furthermore, not all combinations of features described in the example embodiments are essential to the solution means of the disclosure.

### First Example Embodiment

FIG. 1 is a diagram showing an example of a configuration of a risk evaluation device according to a first example embodiment. In the configuration shown in FIG. 1, a risk evaluation device 100 includes a communication unit 110, a display unit 120, an operation input unit 130, a storage unit 180, and a control unit 190. The control unit 190 includes a data acquisition unit 191, a confidence score calculation unit 192, and a risk evaluation unit 193.

The risk evaluation device 100 evaluates the risk of information leakage when a model including a plurality of partial models is used. The risk evaluation device 100 may receive a request to perform a risk evaluation from another device, and then evaluate the risk of information leakage, and notify the requesting device of the evaluation result.

The model referred to here is a model obtained by machine learning (hereunder, also referred to as a “machine learning model”). An example of an attack that causes information leakage from a machine learning model is a membership inference attack. A membership inference attack is an attack that estimates training data by repeatedly executing processing that determines whether or not a certain piece of data is included in the training data used to create the machine learning model, based on an inference result of the machine learning model for the certain piece of data.

The risk evaluation device 100 may, for example, be configured by using a computer such as a personal computer (PC) or a workstation (WS).

Here, the risk evaluation device 100 subjects to risk evaluation a model that has been generated using a data set including a plurality of data in which an explanatory variable (or feature) value list, being a list of values used in a first class classification, and a target variable (objective variable, or label) value, which identifies a class in a second class classification, which is different from the first class classification, have been combined. The model subjected to risk evaluation by the risk evaluation device 100 is also referred to as a target model.

The risk evaluation device 100 may use a target model provided in another device. Alternatively, the risk evaluation device 100 may acquire a target model from another device. Alternatively, the risk evaluation device 100 may generate a target model.

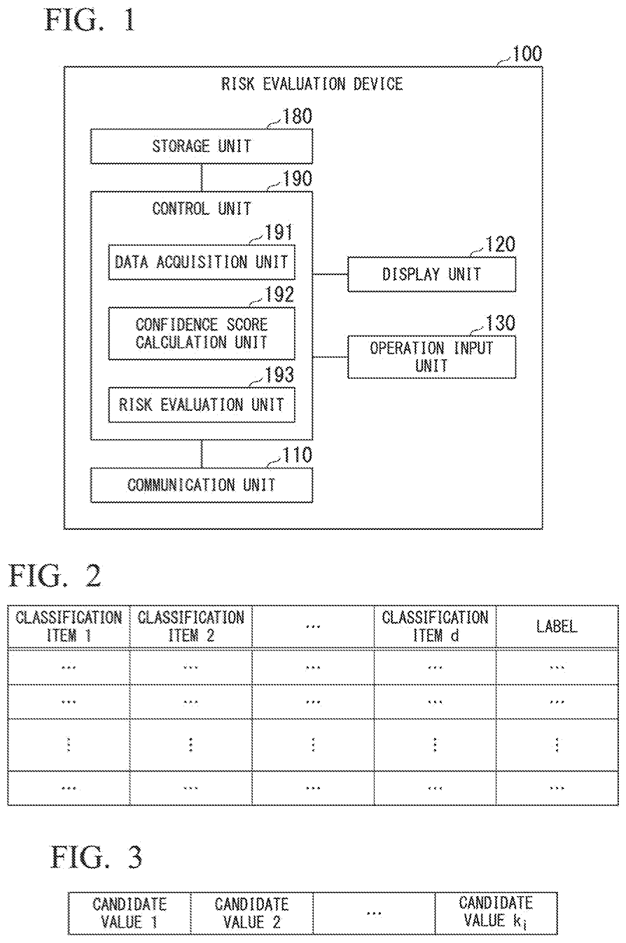

FIG. 2 is a diagram showing an example of a data structure of a data set used to generate a target model.

In the data structure shown in FIG. 2, the data set includes m data. Each data includes values for each of the items “classification item 1”, “classification item 2”, . . . , “classification item d”, and “label”. Here, m is an integer such that m≥2. d is an integer such that d≥1.

Each of the items from “classification item 1” to “classification item d” are also referred to as classification items.

Each of the items from “classification item 1” to “classification item d” are items used to perform a class classification using a partial model. The variables representing the values of the classification items are also referred to as explanatory variables. The values of the classification items are also referred to as explanatory variable values (or feature values).

A list of values of each item from “classification item 1” to “classification item d”, or a list of values of some of the items from “classification item 1” to “classification item d” is also referred to as an explanatory variable value list. A class classification performed by applying a partial model to an explanatory variable value list is also referred to as a first class classification.

Here, to perform a class classification by applying a partial model to an explanatory variable value list is to perform a class classification by applying class classification rules indicated by the partial model to the values of the classification items indicated in the explanatory variable value list.

Applying a model to data is also referred to as inputting data to a model. Acquiring a value from a model is also referred to as a model outputting a value.

Performing a class classification by applying a model to data is also referred to as a class classification of the data.

The value of the “label” item identifies a class in a second class classification, which is different from the first class classification. The variable representing the value of the “label” item is referred to as a target variable. The value of the “label” item is referred to as a target variable value.

Data including an explanatory variable value list and a target variable value is also referred to as target data.

A data set used to generate a model is also referred to as a data set D. The data set D corresponds to an example of a first set.

Furthermore, it is assumed that the possible values that the classification items can take have been defined for each classification item. However, the possible values referred to here may be randomly calculated values. Alternatively, the possible values may be values acquired through a search. The possible values a classification item can take are also referred to as candidate values of the classification item. A list of candidate values of a single classification item is also referred to as a candidate value list.

FIG. 3 is a diagram showing an example of the data structure of a candidate value list for “classification item i”. In the example of FIG. 3, i is an integer such that 1≤i≤d. d represents the number of classification items.

In the example of FIG. 3, “classification item i” takes any one of kᵢ values from candidate value 1, candidate value 2, . . . , candidate value kᵢ. kᵢ is an integer such that kᵢ≥1, and represents the number of candidate values of “classification item i”. The candidate value list of “classification item i” is a list containing candidate value 1, candidate value 2, . . . , candidate value kᵢ.

When generating a target model, a data set corresponding to part of the data set D is extracted in a plurality of ways, and a partial model is generated for each extracted data set. A data set corresponding to part of the data set D is also referred to as a data set DSUB. The data set DSUB corresponds to an example of a second set.

For example, extraction of the data set DSUB can be performed as follows.
Step 1: Select one or more data from the m target data included in the data set D, and select one or more classification items from the d classification items shown in the data set D.
Step 2: Extract the selected target data from the data set D.
Step 3: For each extracted target data, extract the values of the selected classification items to form a list, and then create data in which the obtained list and the target variable value included in the target data have been combined.
Step 4: Group the data generated for each target data in step 3 to form a data set DSUB. The data generated in step 3 corresponds to an example of elements of a predetermined set. Furthermore, the data generated in step 3 corresponds to an example of target data.

In step 1, all m target data included in the data set D may be selected. Moreover, in step 1, all d classification items shown in the data set D may be selected.

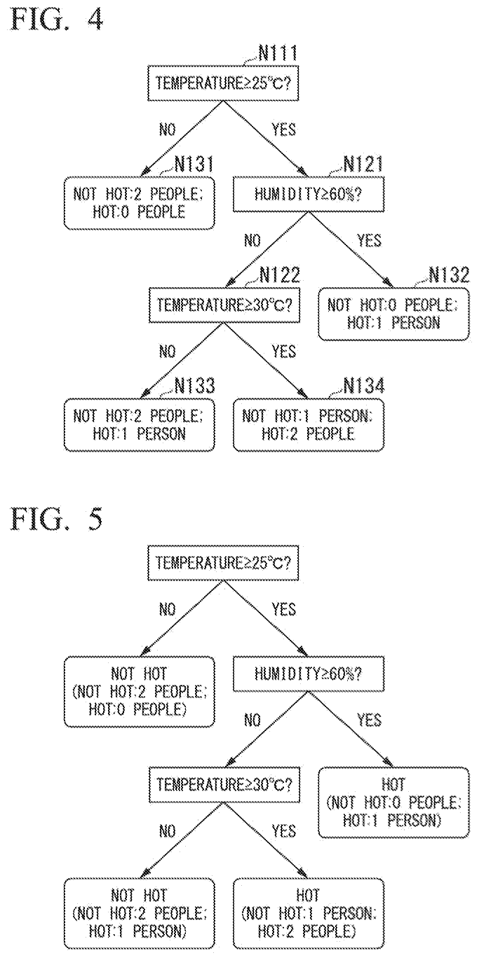

FIG. 4 is a diagram showing a first example of a partial model.

FIG. 4 represents an example of a partial model where the classification items included in the data set DSUB are temperature and humidity, and the target variable value represents whether people feel hot, or do not feel hot.

In the example of FIG. 4, the partial model is configured as a tree-structured model. The nodes N111, N121 and 122, which respectively correspond to a root and intermediate nodes, represent branching conditions relating to either the temperature or the humidity. Here, the nodes other than the root and leaves are referred to as intermediate nodes. The nodes N131, N132, N133 and N134, which correspond to the leaves, each indicate the number of people that feel hot, and the number of people that do not feel hot.

In the leaves, “not hot” represents people that do not feel hot. “Hot” represents people that feel hot. Furthermore, one target data corresponds to the data for one person. The number of people indicated in each class represents the number of data that have been classified into that class.

In the partial model shown in FIG. 4, following the branching conditions from the root and reaching a leaf corresponds to an example of a first class classification. The “not hot” and “hot” indicated in the leaf corresponds to examples of classes in a second class classification.

The number of people that are indicated in the leaves for each of “not hot” and “hot” represents an example of the number of elements among the elements of the data set D that, for each class in a class classification performed using a combination of a first class classification and a second class classification, are classified into that class. Indicating the number corresponds to an example of indicating the degree to which, for each class in a class classification performed using a combination of a first class classification and a second class classification, the elements of the data set D are classified into that class.

The method of generating a partial model using the data set DSUB is not limited to a specific method. For example, a known decision tree generation algorithm may be used as the method of generating a partial model using the data set DSUB.

The decision tree referred to here is a tree that indicates a branching condition in the root and each intermediate node, and indicates, in each leaf, data that corresponds to the conditions represented by the path from the root until reaching the leaf.

The processing that generates a model from the data set D can be regarded as a type of machine learning. In this case, the data set D can be regarded as a training data set. Each of the target data included in the data set D can be regarded as individual training data. The explanatory variable value list included in the target data can be regarded as a sample of input data to a model. The target variable value included in the target data can be regarded as the correct output data (teacher data) of a model for input data represented by the explanatory variable value list.

When the data set DSUB is extracted in a plurality of ways from the data set D, and a tree-structured partial model is generated for each data set DSUB, the obtained model, or the model generation algorithm, can be regarded as a type of random forest.

FIG. 5 is a diagram showing a second example of a partial model.

In the example of FIG. 5, a value (“not hot” or “hot”) based on a majority vote between “not hot” and “hot” is additionally shown in each leaf in the example of FIG. 4. The partial model shown in FIG. 5 is the same as the partial model shown in FIG. 4 in all other respects.

The value obtained based on the majority vote between “not hot” and “hot” can, for example, be used to calculate an estimated value for each partial model when each partial model receives an input of an explanatory variable value list and outputs an estimated value of “not hot” or “hot”.

The partial model shown in FIG. 5 can be regarded as a tree in which the basis of the class classification is shown in the leaves of the classification tree. The classification tree referred to here is a tree that represents the class classification rules.

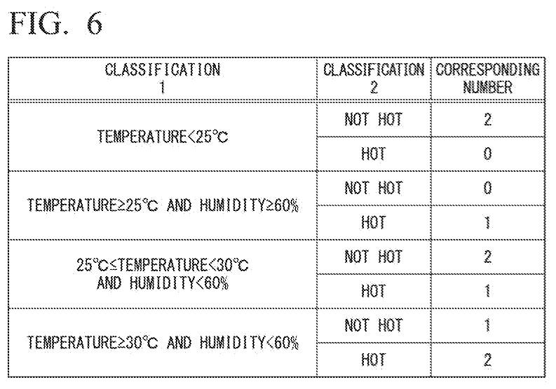

FIG. 6 is a diagram showing a third example of a partial model.

In the example of FIG. 6, the partial model of the example of FIG. 4 is shown in a table format. The item “classification 1” represents the classification conditions used in the first class classification. The item “classification 2” represents the class in the second class classification. The “applicable number” item represents the number of people that correspond to the conditions shown in “classification 1” and “classification 2”.

In this way, the expression format of the target model is not limited to a specific format. On the other hand, when the partial model is represented using a tree structure as in the example of FIG. 4 or the example of FIG. 5, a class classification can be performed by the relatively simple processing of following the conditions shown in the root and the intermediate nodes from the root to a leaf.

The target model can, for example, be used for estimation using an ensemble method. The ensemble method referred to here is a method in which a plurality of partial models each output an estimated value, and the estimated value of the entire model is determined based on a majority vote of the estimated values of the partial models.

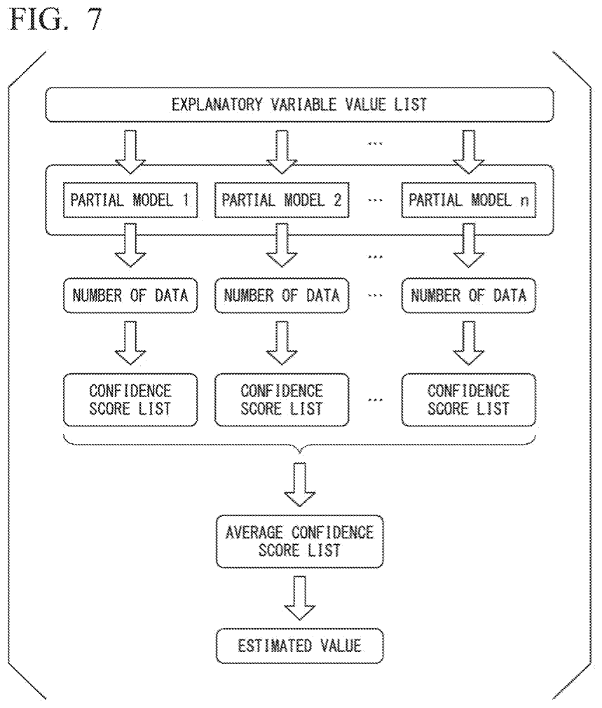

FIG. 7 is a diagram showing an example of data input and output in an estimation using a target model.

In the example of FIG. 7, an estimation device that performs estimation using a target model applies each of n partial models that are included in the target model to an explanatory variable value list. As a result, for each partial model, and for each class in the second class classification, the number of data that are classified into a class that is classified in the first class classification with respect to the explanatory variable value list, and classified into that class in the second class classification, is obtained.

The risk evaluation device 100 may be made to operate as an estimation device. Alternatively, a device other than the risk evaluation device 100 may be made to operate as an estimation device.

The estimation device may convert, for each partial model, the number of data in each class in the second class classification into a ratio between classes. In this case, the sum of the ratios may be the same for each partial model, such as 1. The ratio in each class corresponds to an example of a confidence score described below. A list in which the ratios for all of the classes in the second class classification have been grouped, corresponds to an example of a confidence score list. The confidence score list may be configured by grouping the confidence scores in a vector.

The average of the confidence scores indicated by each partial model for the entire target model is also referred to as an average confidence score. A list in which the average confidence scores for all of the classes in the second class classification have been grouped, corresponds to an average confidence score list. The average confidence score list may be configured by grouping the average confidence scores in a vector.

Further, the estimation device may calculate, for each class in the second class classification, an average value of the ratios in the entire target model. The average value of the ratios corresponds to an example of an average confidence score.

In addition, the estimation device may determine that, of the classes in the second class classification, the class for which the largest average value of the ratios has been obtained is the estimated value of the target model.

A confidence score list that has been adjusted such that the sum of the ratios indicated by each element becomes 1 can be regarded as values that probabilistically indicate the estimated value of the partial model. The average confidence score list in this case can be regarded as values that probabilistically indicate the estimated value of the target model.

Alternatively, the estimation device may determine an estimated value for each partial model by selecting, for each partial model, one of the classes by a majority vote of the number of data in each of the classes in the second class classification. Further, the estimation device may determine an estimated value of the target model by selecting, by a majority vote of the estimated value of each partial model, one of the classes in the second class classification.

In the example of FIG. 4, the first class classification can be performed by following each partial model from the root to a leaf according to the explanatory variable value list of the classification items, which includes the temperature and the humidity. Then, in each partial model, the estimated value of the partial model can be determined by a majority vote of the values (number of data) for each class in the second class classification, which is indicated in the leaf that has been reached.

For example, when the node N133 in FIG. 4 has been reached, as a result of the majority vote between “2 people” indicated for “not hot”, and “1 person” indicated for “hot”, it is possible to determine that the estimated value of the partial model shown in FIG. 4 is “not hot”. Then, by using a majority vote of the estimated values from the partial models, it is possible to determine that the estimated value of the target model is either “not hot” or “hot”.

Alternatively, the number of people obtained in each partial model for each of “not hot” and “hot” may be added together, and the larger total number of people among “not hot” and “hot” may be determined to be the estimated value of the target model.

Here, a case will be considered where the target model is published.

In this case, when it is assumed that there is a person that possesses target data in which the values of some of the classification items are unknown, and the person knows the values that can be taken by the unknown classification items, there is a possibility that the person may be able to estimate the unknown values by using the published target model. In this case, the estimation of the unknown values can be regarded as the use of the target model for a purpose other than that intended by the publisher of the target model, and in this respect, can be considered a type of information leakage. Alternatively, it can be regarded as a type of information leakage in which, by estimating the unknown values, data including the values is identified from among the training data, which is the basis for creating the target model. In other words, it is possible for a piece of data to be leaked in the field of computer security as a result of a cyberattack that specifies a piece of training data while using a confidence score.

The target data in which the values of one or more classification items is unknown is also referred to as original target data. The original target data may be target data that is handled as data in which the values of one or more classification items is unknown for the purpose of risk evaluation.

Alternatively, a case can be considered where a person that knows the candidate values of each classification item generates an explanatory variable value list by setting the values of some of the classification item as unknown, and the values of the other classification items to one of the candidate values. For example, it is plausible that the person may input a target model by generating an explanatory variable value list for various combinations of the candidate values of the classification items, and estimate the target data included in the data set D based on the obtained results.

Such an estimation of the data can be regarded as the use of the target model for a purpose other than that intended by the publisher of the target model, and in this respect, can be considered a type of information leakage.

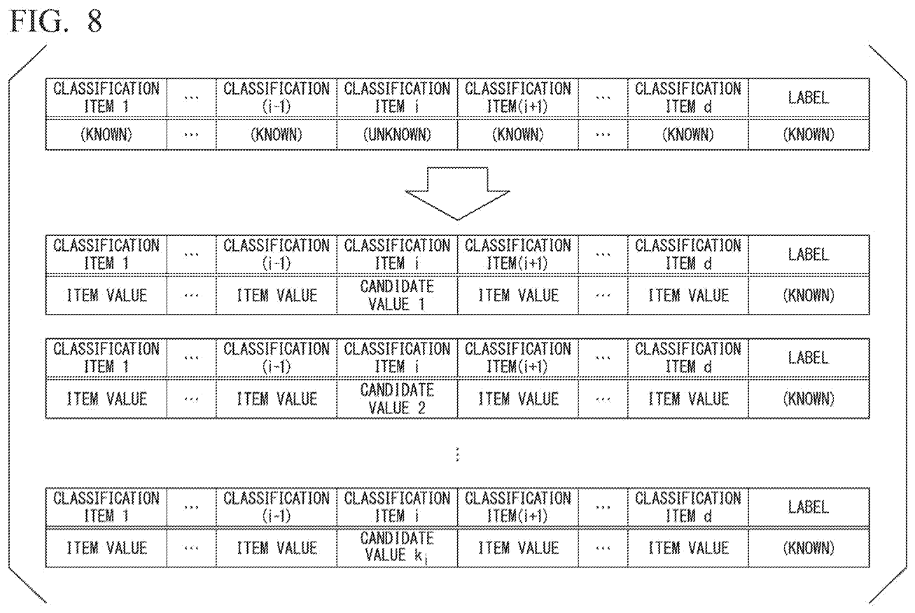

FIG. 8 is a diagram showing an example of generating target data for estimating an unknown value of a classification item.

In the original target data shown in FIG. 8, of the d target data from “classification item 1” to “classification item d”, the value of “classification item i” is unknown, and the values of the other classification items are known. Here, i is an integer such that 1≤i≤d. Alternatively, all of the classification item values may be unknown.

Here, the values that can be taken by “classification item i” are assumed to be candidate value 1, candidate value 2, . . . , candidate value Kᵢ. As the input data to the target model for estimating the value of “classification item i”, it is plausible to generate, for each value that can be taken by “classification item i”, target data in which the value of “classification item i” in the original target data has been set.

If it is possible to estimate a possibility that one of the generated kᵢ target data are included in the data set D, it is possible to estimate the value of “classification item i” in the original target data.

Therefore, the risk evaluation device 100 generates, from the target data included in the data set D, target data in which one or more classification items have been set with the respective candidate values of the classification items, and calculates, for each of the generated target data, a score indicating a possibility that the target data is included in the data set D.

The target data obtained by setting the candidate values of the classification items to the classification items in the original target data with unknown values (or classification items treated as having unknown values) is also referred to as search data.

In the configuration of FIG. 1, the communication unit 110 performs communication with other devices. For example, the communication unit 110 may acquire a target model and a candidate value list by performing communication with a server device that is storing the target model and the candidate value list.

Further, for example, the communication unit 110 may be provided as a server device, and the communication unit 110 may receive a request to perform risk evaluation of information leakage of a target model. Then, the communication unit 110 may transmit the evaluation result to the source of the request.

The display unit 120 includes, for example, a display screen such as a liquid crystal panel or an LED (light emitting diode) panel, and displays various images. For example, the display unit 120 may display the evaluation results of information leakage.

The operation input unit 130 includes input devices such as a keyboard and a mouse, and receives user operations. For example, the operation input unit 130 may receive user operations that instruct the risk evaluation of information leakage to be started.

The storage unit 180 stores various data. For example, the storage unit 180 stores a target model, a candidate value list, and target data. The storage unit 180 is configured by using a storage device included in the risk evaluation device 100.

The control unit 190 performs various processing that controls each unit of the risk evaluation device 100. The functions of the control unit 190 are executed as a result of a CPU (central processing unit) included in the risk evaluation device 100, reading and executing a program from the storage unit 180.

The data acquisition unit 191 acquires target data to be input to a target model. As mentioned above regarding the risk evaluation device 100, the data acquisition unit 191 acquires target data in which the values of one or more classification items are unknown, and for each candidate value of a classification item with an unknown value, sets the candidate value to the classification item. As a result, the data acquisition unit 191 generates target data for each candidate value.

The data acquisition unit 191 corresponds to an example of a data acquisition means.

Each of the target data that is generated by the data acquisition unit 191 for each candidate value corresponds to search data.

The risk evaluation device 100 may acquire target data in which the values of one or more classification items are unknown, from another device, and the data acquisition unit 191 may set the classification items with unknown values to the candidate values.

Alternatively, the risk evaluation device 100 may acquire the data set D, and the data acquisition unit 191 may treat the values of at least one of the classification items in the target data included in the data set D as unknown, and set the candidate values to the classification items.

In this case, the data acquisition unit 191 may randomly select the target data from the data set D, and randomly determine the classification items assumed to have unknown values.

Alternatively, for each target data included in the data set D, the data acquisition unit 191 may predict that all of the patterns in a predetermined number or less of the classification items, such as one classification item, have unknown values, and generate, for each predicted pattern, and for each candidate value of the classification items that are assumed to have unknown values, search data by setting the candidate values to the classification items.

Alternatively, the user may specify which of the target data are included in the data set D, and specify, among the specified target data, the classification items that are assumed to have unknown values.

Hereunder, an example will be described where the risk evaluation device 100 obtains target data in which one classification item has an unknown value, and the risk of leakage of the value of the classification item is evaluated.

When there are a plurality of classification items with unknown values, the data acquisition unit 191 may set, to a combination of classification items with unknown values, a combination of candidate values of the classification items. For example, the data acquisition unit 191 may group the classification items with unknown values into a single vector. As a result of grouping the classification items with unknown values into a single group, the risk evaluation device 100 can evaluate the risk of information leakage using the same processing as a case where the number of classification items with unknown values is 1.

Alternatively, when there is a plurality of classification items with unknown values, the data acquisition unit 191 may select one of the classification items with an unknown value, and generate partial data of the target data in which the other classification items with unknown values (the classification items other than the selected classification item) have been excluded from the target data. As a result, the risk evaluation device 100 is capable of evaluating the risk of information leakage using the processing used in a case where the number of classification items with unknown values is 1.

In this case, it is assumed that, when a conditional branch relating to an excluded classification item is included in the conditional branches shown in a partial model, the values obtained at each branch destination in the conditional branch are summed. For example, when the partial model is represented by a tree structure, and a node representing a conditional branch relating to an excluded classification item has been reached, the value shown at each leaf that can be reached by following each branch from that node is summed for each class in the second class classification.

The risk evaluation device 100 is capable of evaluating the risk of information leakage for each classification item with an unknown value by evaluating the risk of information leakage by generating partial data as described above for each classification item with an unknown value.

The confidence score calculation unit 192 calculates, for each partial model, and for each search data, an index value indicating a degree to which an element of the data set DSUB is classified into the class that is classified by the first class classification, which is performed by applying the partial model to the explanatory variable value list included in the search data, and the class among the classes in the second class classification that is identified by the target variable value included in the search data. The index value is also referred to as a confidence score. A list in which the confidence scores for all of the classes in the second class classification have been grouped is also referred to as a confidence score list. As described above, the confidence score list may be configured by grouping the confidence scores as a vector.

The confidence score calculation unit 192 corresponds to an example of a confidence score calculation means.

Specifically, the confidence score calculation unit 192 performs a first class classification by applying a partial model to the explanatory variable value list included in the search data. Then, the confidence score calculation unit 192 acquires the class that has been reached in the first class classification, and the number of data that have been classified into the class, which is indicated for each class in the second class classification. The confidence score calculation unit 192 converts the obtained number for each class into a ratio of the number for each class, and uses a vector representing the converted ratios as a confidence score list. At the time of conversion, the confidence score calculation unit 192 ensures that the sum of the ratios (the sum of the confidence scores included in the confidence score list) is 1.

For example, in the case of the partial model of FIG. 4, the confidence score calculation unit 192 follows the tree (tree-structured partial model) from the root to a leaf based on the explanatory variable value list included in the search data. The processing that follows the tree from the root to a leaf corresponds to an example of a first class classification.

Further, the confidence score calculation unit 192 reads the number of data for each class in the second class classification, which is shown in the leaf that has been reached. For example, when the confidence score calculation unit 192 reaches the node N131, “not hot: 2 people” and “hot: 0 people” is read as shown in the node N131. The “not hot” and “hot” each correspond to an example of a target variable value that identifies a class in the second class classification. The “2 people” and “0 people” each indicate, among the target data included in the data set DSUB used to generate the partial model, the number of target data that have been classified into the corresponding classes.

The confidence score calculation unit 192 converts the obtained number of data 2 and 0, into ratios that sum to 1, and calculates the confidence score list (1, 0).

The values of the elements of the confidence score list indicate, among the target data included in the data set DSUB used to generate the partial model, the number of target data that have been classified into the classes corresponding to the elements.

Here, the confidence scores (the values of the elements of the confidence score list) are calculated for each class in a class classification performed using a combination of a first class classification and a second class classification. When the confidence score of a certain class has been calculated, the class is also referred to as the class corresponding to the confidence score.

The data set DSUB used to generate the partial model is a set obtained by partially extracting data from the data set D, which is used to generate the target model. Therefore, when a class classification is performed by applying a partial model to each of the target data included in the data set D, there is considered to be a positive relationship between the confidence score and the number of target data that are classified into the class corresponding to the confidence score. In this respect, the confidence score is regarded as an index value of the degree to which the target data, which is an element of the data set D, is classified into the class corresponding to the confidence score. Alternatively, the confidence score can also be regarded as a degree of certainty of classification into a certain single class (or label). It can also be said that a confidence score of 1 with respect to data indicates that there is a high possibility that the data is included in the training data.

However, the expression format of the confidence score is not limited to a specific format. For example, the confidence score calculation unit 192 may use the number of obtained data as the confidence score as is, without converting the number into a ratio. In the case of the node N131 described above, the confidence score calculation unit 192 may calculate the confidence score corresponding to temperature ≥25° C. and “not hot” as 2, and calculate the confidence score corresponding to temperature ≥25° C. and “hot” as 0.

The risk evaluation unit 193 evaluates, based on the confidence scores calculated for each search data and each partial model by the confidence score calculation unit 192, the possibility that the search data is included in the data set D.

The risk evaluation unit 193 corresponds to an example of a risk evaluation means.

For example, the risk evaluation unit 193 calculates an index value of the possibility that the search data is included in the data set D.

Specifically, the risk evaluation unit 193 generates, for each partial model, a list of candidate values that, among the candidate values of the classification items in the original target data with unknown values, have a confidence score of 0 in the partial model. This list is also referred to as an exclusion list.

Here, a candidate value with a confidence score is 0 in a certain model is a candidate value in which the confidence score of the classification destination class, which is from performing class classification by applying the partial model to search data obtained by setting the candidate value to the original target data, is 0.

Furthermore, when a confidence score of a classification destination is obtained by performing class classification by applying a certain partial model to search data obtained by setting a certain candidate value to certain target data, the candidate value is also referred to as a candidate value corresponding to the confidence score.

Then, the risk evaluation unit 193 counts, for each candidate value of the classification items in the original target data with an unknown value, the number of exclusion lists among the exclusion lists for each partial model that include the candidate value, and creates a list of the counted number for each candidate value. This number is also referred to as a non-applicability score. A list of non-applicability scores is also referred to as a non-applicability score list.

When the confidence score that corresponds to the search data is 0, it is an indication that, among the target data included in the data set DSUB used to generate the partial model that is the subject of the confidence score, there is no target data that is classified into the class that corresponds to the confidence score. As a result, when the confidence score corresponding to the search data is 0, when each target data included in the data set D is input to the partial model, the possibility that target data that is classified into the class that corresponds to the confidence score does not exist can be evaluated to be high.

The confidence score corresponding to the search data (or target data) referred to here is a confidence score obtained by applying a partial model to the search data (or target data).

Therefore, candidate values having a higher non-applicability score can be evaluated as having a lower possibility of the search data obtained by setting the candidate value to the original target data being included in the data set D. Conversely, candidate values having a lower non-applicability score can be evaluated as having a higher possibility of the search data obtained by setting the candidate value to the original target data being included in the data set D.

From this, as the lowest value of the elements in the non-applicability score list decreases, it is possible to evaluate that the possibility that the search data, which has been obtained by setting the candidate value that results in the lowest value of the elements in the non-applicability score list to the original target data, is included in the data set D is higher. In this respect, the non-applicability score list corresponds to an example of an index value of the possibility that the search data is included in the data set D.

Furthermore, the possibility that the obtained search data is included in the data set D being high can be regarded as the risk of leakage of the target data that is included in the data set D being high. In this respect, the non-applicability score list corresponds to a list of evaluation values of the risk of information leakage. Therefore, the risk evaluation unit 193 generating a non-applicability score list corresponds to an example of evaluating the risk of information leakage.

In the processing described above, for example, it can be said that the risk evaluation device 100 (or the data protection device described below) specifies, for a machine learning model including a plurality of partial models, the data in each partial model having a vulnerability to a membership inference attack ((or having a confidence score of 1, or near 1) and having a possibility of information leakage). The risk evaluation device 100 (or the data protection device described below) creates, for the plurality of partial models, data in which the specified data (that is to say, candidate values having a small non-applicability score) has been merged. The risk evaluation device 100 (or the data protection device described below) may output, for the created data, a score having a value that is different from a score that is calculated by the plurality of partial models (such as the confidence score).

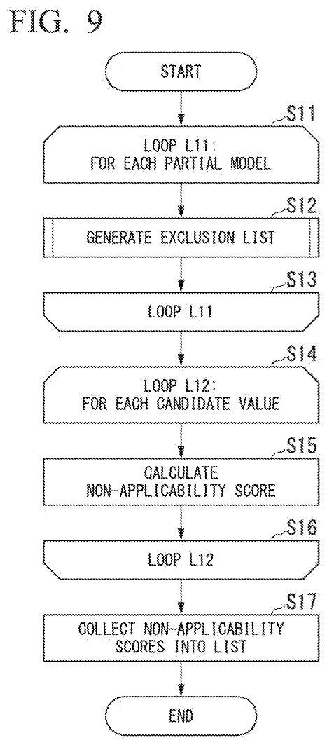

FIG. 9 is a diagram showing an example of the processing procedure performed by the risk evaluation device 100 when the risk evaluation unit 193 generates a non-applicability score list according to the first example embodiment.

In the processing of FIG. 9, the control unit 190 starts loop L11, which performs processing for each partial model (step S11).

In the processing of loop L11, the risk evaluation unit 193 generates an exclusion list of the partial model subjected to the processing of loop L11 (step S12).

Then, the control unit 190 performs termination processing of loop L11 (step S13). Specifically, the control unit 190 determines whether or not the processing of loop L11 has been performed for all partial models included in the target model. If the control unit 190 determines that there is a partial model that has not yet been subjected to the processing of loop L11, the processing returns to step S11, and the control unit 190 continues to perform the processing of loop L11 on the unprocessed partial model. On the other hand, if it is determined that the processing of loop L11 has been performed for all of the partial models included in the target model, the control unit 190 terminates loop L11.

After terminating loop L11 in step S13, the control unit 190 starts loop L12, which performs processing for each candidate value of a classification item in the original target data with an unknown value (step S14).

In the processing of loop L12, the risk evaluation unit 193 calculates the non-applicability scores of the candidate values subjected to the processing of loop L12 (step S15).

Then, the control unit 190 performs termination processing of loop L12 (step S16). Specifically, the control unit 190 determines whether or not the processing of loop L12 has been performed for all candidate values of the classification items in the original target data with an unknown value. If the control unit 190 determines that there is a candidate value that has not yet been subjected to the processing of loop L12, the processing returns to step S14, and the control unit 190 continues to perform the processing of loop L12 on the unprocessed candidate value. On the other hand, if it is determined that the processing of loop L12 has been performed for all candidate values of the classification items in the original target data with an unknown value, the control unit 190 terminates loop L12.

When the control unit 190 has terminated loop L12 in step S16, the risk evaluation unit 193 generates a non-applicability score list by collecting the non-applicability scores that have been calculated for each candidate value in step S15 into a list (step S17).

After step S17, the risk evaluation device 100 ends the processing of FIG. 9.

When there are a plurality of original target data (that is to say, when there are a plurality of target data in which the value of a certain classification item is unknown), the risk evaluation device 100 performs the processing of FIG. 9 for each of the original target data.

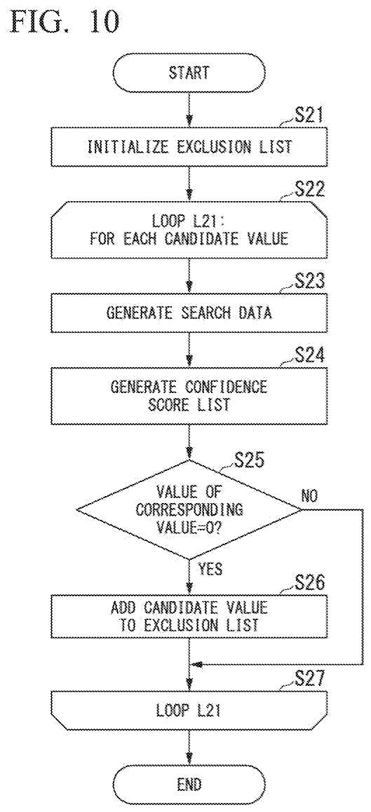

FIG. 10 is a diagram showing an example of the processing procedure performed by the risk evaluation device 100 when the risk evaluation unit 193 generates an exclusion list. In the risk evaluation device 100, the processing of FIG. 10 is performed in step S12 of FIG. 9.

In the processing of FIG. 10, the risk evaluation unit 193 initializes an exclusion list (step S21). Specifically, the risk evaluation unit 193 sets the initial value of the exclusion list to a null list (a list with 0 elements).

Then, the control unit 190 starts loop L21, that performs processing for each candidate value of a classification item in the original target data with an unknown value (step S22).

In the processing of loop L21, the data acquisition unit 191 generates search data (step S23). Specifically, the data acquisition unit 191 generates search data by setting the classification item in the original target data with an unknown value, to the candidate value that is subjected the processing of loop L21.

Then, the confidence score calculation unit 192 generates a confidence score list (step S24). Specifically, the confidence score calculation unit 192 performs a first class classification by applying a partial model (the partial model that is subjected to the processing of loop L11 in FIG. 9) to the explanatory variable value list of the search data generated in step S23. Then, the confidence score calculation unit 192 acquires the class that has been reached in the first class classification, and the number of data that have been classified into that class, which is indicated for each class in the second class classification. The confidence score calculation unit 192 converts the obtained number for each class into a ratio of the number, and obtains a vector representing the converted ratios as a confidence score list. When converting the number to a ratio, the confidence score calculation unit 192 performs the conversion such that the sum of the ratios becomes 1.

Then, the risk evaluation unit 193 determines whether or not the value of the corresponding component in the confidence score list generated in step S24 is 0 (step S25). The corresponding component in the confidence score list referred to here is the element (confidence score) among the elements of the confidence score list that corresponds to the candidate value that is subjected to the processing by loop L21.

If it is determined that the value of the corresponding component is 0 (step S25: YES) the risk evaluation unit 193 adds the candidate value that is subjected to the processing of loop L21 to the exclusion list (step S26).

Then, the control unit 190 performs termination processing of loop L21 (step S27). Specifically, the control unit 190 determines whether or not the processing of loop L21 has been performed for all candidate values of the classification items in the original target data with an unknown value. If the control unit 190 determines that there is a candidate value that has not yet been subjected to the processing of loop L21, the processing returns to step S22, and the control unit 190 continues to perform the processing of loop L21 on the unprocessed candidate value. On the other hand, if it is determined that the processing of loop L21 has been performed for all candidate values of the classification items in the original target data with an unknown value, the control unit 190 terminates loop L21.

On the other hand, in step S25, if the risk evaluation unit 193 determines that the value of the corresponding component is not 0 (step S25: NO) the processing proceeds to step S27.

In step S27, if the control unit 190 has terminated loop L21, the risk evaluation device 100 ends the processing of FIG. 10.

As described above, the data acquisition unit 191 acquires target data. The target data is data including an explanatory variable value list and a target variable value. The explanatory variable value list is a list of values of classification items, being items used to perform the first class classification. The target variable value is a value used to identify a class in the second class classification.

The confidence score calculation unit 192 calculates confidence scores for each partial model of the target model. The target model is a model including, for each class in a class classification performed using a combination of a first class classification and a second class classification, partial models indicating the degree to which the elements of the data set DSUB are classified into the class for each of the plurality of ways of performing the first class classification. The data set DSUB is a set that is generated from the data set D for each partial model. The confidence score indicates the degree to which an element of the data set DSUB is classified into a class that is classified in the first class classification with respect to the explanatory variable value list included in the target data, and a class in the second class classification which is identified by the target variable value included in the target data.

The risk evaluation unit 193 evaluates the possibility that the target data is included in the data set D based on the confidence score of each partial model.

According to the risk evaluation device 100, it is possible to evaluate the possibility that the target data obtained using the target model is included in the data set D. According to the risk evaluation device 100, in this respect, it is possible to evaluate the risk of information leakage when a model including a plurality of partial models is used.

Furthermore, a partial model of a target model is a decision tree representing the first class classification by branching.

According to the risk evaluation device 100, a class classification can be performed by the relatively simple processing of following the conditions shown in the root and the intermediate nodes from the root to a leaf.

Furthermore, a partial model of a target model indicates, for each class in a class classification performed using a combination of a first class classification and a second class classification, the number of elements among the elements of the data set DSUB that are classified into the class. The confidence score calculation unit 192 calculates a confidence score, which indicates, for a single class in the first class classification, a ratio of the number of elements among the elements of the data set DSUB that are classified into each class in the second class classification.

According to the risk evaluation device 100, when performing an estimation using a target model, it is possible to determine an estimated value using a confidence score.

In addition, the data acquisition unit 191 generates the target data subjected to calculation of the confidence score by setting, to the target data in which the values of one or more classification items are unknown, candidate values of the classification items with unknown values.

According to the risk evaluation device 100, the processing of risk evaluation can be simplified in the respect that the risk evaluation of information leakage is performed by setting candidate values to the classification items with unknown values.

Furthermore, the risk evaluation unit 193 calculates, for each candidate value included in the list of candidate values of classification items with an unknown value, a non-applicability score that indicates, for target data in which the candidate value has been set, the number of partial models indicating that there are no elements among the elements of the data set DSUB that are classified into a class that has been classified in the first class classification, which is performed with respect to the explanatory variable value list included in the target data, and a class of the second class classification, which is identified by the target variable value included in the target data.

A candidate value having a lower non-applicability score can be evaluated as having a higher possibility of the target data (search data) obtained using the candidate value being included in the data set D. In this respect, according to the risk evaluation device 100, the risk of information leakage can be evaluated.

### Second Example Embodiment

A risk evaluation device may estimate the value of a classification item with an unknown value. This example aspect will be described in a second example embodiment.

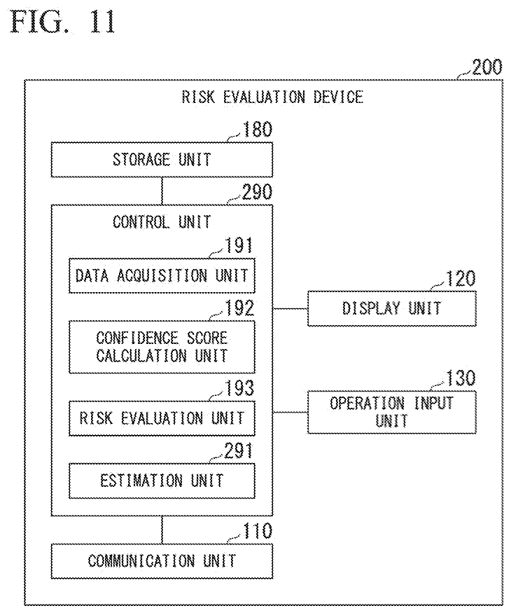

FIG. 11 is a diagram showing an example of a configuration of a risk evaluation device according to the second example embodiment. In the configuration shown in FIG. 11, a risk evaluation device 200 includes a communication unit 110, a display unit 120, an operation input unit 130, a storage unit 180, and a control unit 290. The control unit 290 includes a data acquisition unit 191, a confidence score calculation unit 192, a risk evaluation unit 193, and an estimation unit 291.

Of the units in FIG. 11, those units having the same functions as the units shown in FIG. 1 are designated by the same reference symbols (110, 120, 130, 180, 191, 192, and 193), and a detailed description will be omitted here. The risk evaluation device 200 of FIG. 11 differs from the risk evaluation device 100 in the aspect that the control unit 290 further includes the estimation unit 291 in addition to the units provided in the control unit 190 of FIG. 1. The risk evaluation device 200 is the same as the risk evaluation device 100 in all other respects.

The estimation unit 291 estimates the value of a classification item with an unknown value. Specifically, the estimation unit 291 sets, among the candidate values included in a list of candidate values of the classification item with an unknown value, the candidate value having the lowest non-applicability score as the estimated value of the classification item.

The estimation unit 291 corresponds to an example of an estimation means.

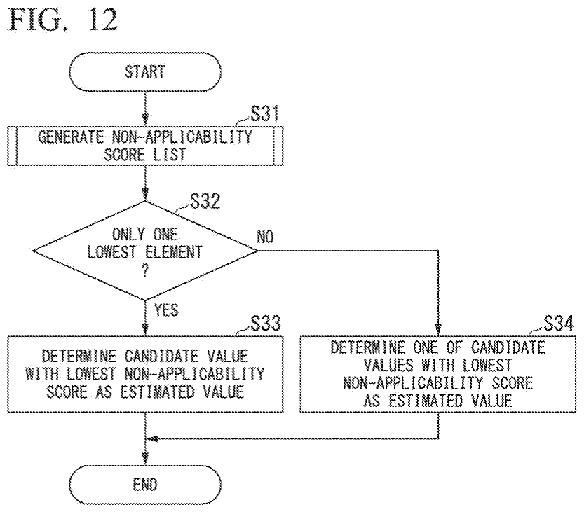

FIG. 12 is a diagram showing a first example of the processing procedure performed by the risk evaluation device 200 when an estimation unit 291 estimates the value of a classification item.

In the processing of FIG. 12, the risk evaluation unit 193 generates a non-applicability score list (step S31). Specifically, the risk evaluation device 200 performs the processing of FIG. 9 in step S31.

Then, the estimation unit 291 determines whether or not there is only one element among the elements of the obtained non-applicability score list having the lowest value (step S32). The non-applicability score list represents, for each estimated value of a classification item with an unknown value, the non-applicability score of the estimated value.

If it is determined that there is only one element with the lowest value (step S32: YES), the estimation unit 291 determines the candidate value corresponding to the element to be the estimated value of the classification item with the unknown value (step S33). That is to say, the estimation unit 291 determines the candidate value having the lowest non-applicability score to be the estimated value of the classification item with the unknown value.

As mentioned above, the candidate value corresponding to a confidence score (element of a confidence score list) is a candidate value of the search item that has been set to the search data from which the confidence score was obtained.

After step S33, the risk evaluation device 200 ends the processing of FIG. 12.

On the other hand, if it is determined that there is a plurality of elements with the lowest value (step S32: NO), the estimation unit 291 determines the candidate value corresponding to any one of the elements having the lowest value to be the estimated value of the classification item with the unknown value (step S34). That is to say, the estimation unit 291 determines any one of the candidate values having the lowest non-applicability score to be the estimated value of the classification item with the unknown value.

The estimation unit 291 may also randomly select any one of the candidate values having the lowest non-applicability score.

After step S34, the risk evaluation device 200 ends the processing of FIG. 12.

If there are a plurality of elements among the elements of the non-applicability score list having the lowest value, the estimation unit 291 may not determine (set as undetermined) an estimated value of the classification item with the unknown value. Here, if there are a plurality of elements among the elements of the non-applicability score list having the lowest value, this can be regarded as a situation in which the estimated value of the classification item with the unknown value cannot be estimated with a high accuracy from the non-applicability scores. In this case, by not determining the estimated value of the classification item with the unknown value, the estimation unit 291 can indicate that the estimated value cannot be estimated with a high accuracy.

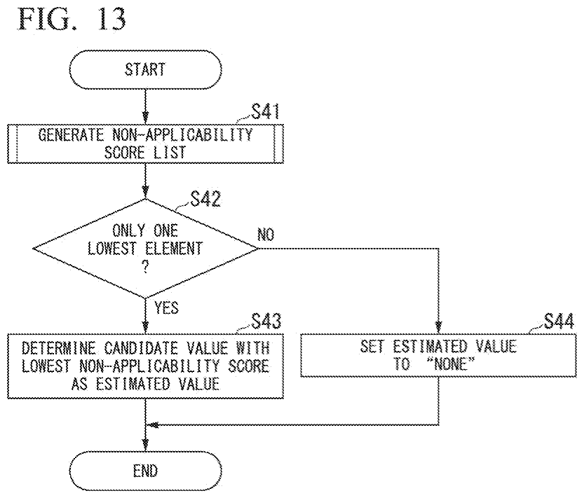

FIG. 13 is a diagram showing a second example of the processing procedure performed by the risk evaluation device 200 when an estimation unit 291 estimates the value of a classification item.

Steps S41 and S42 in FIG. 13 are the same as steps S31 and S32 in FIG. 12.

In step S42, if the estimation unit 291 determines that there is only one element with the lowest value (step S42: YES), the processing proceeds to step S43.

Step S43 is the same as step S33 in FIG. 12.

After step S43, the risk evaluation device 200 ends the processing of FIG. 12.

On the other hand, in step S42, if it is determined that there are a plurality of elements with the lowest value (step S42: NO), the estimation unit 291 sets the estimated value of the classification item with the unknown value to “None” (step S44). “None” indicates that the value has not been determined, that is to say, the value is undetermined.

After step S44, the risk evaluation device 200 ends the processing of FIG. 13.

If there are a plurality of target data (that is to say, original target data) with one or more classification items with unknown values, the risk evaluation device 200 may generate a list representing the target data among the plurality of target data for which an estimated value has been determined, and the estimated values that have been determined. This list is also referred to as an estimated value list.

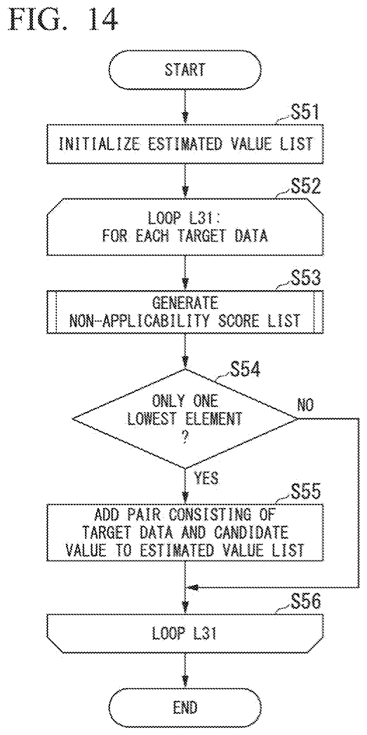

FIG. 14 is a diagram showing a third example of the processing procedure performed by the risk evaluation device 200 when an estimation unit 291 estimates the value of a classification item.

In the processing of FIG. 14, the estimation unit 291 initializes an estimated value list (step S51). Specifically, the estimation unit 291 sets the initial value of the estimated value list to a null list (a list with 0 elements).

Then, the control unit 290 starts loop L31, which performs processing for each original target data (step S52).

Steps S53 and S54 in FIG. 14 are the same as steps S31 and S32 in FIG. 12.

In step S54, if it is determined that there is only one element with the lowest value (step S54: YES), the estimation unit 291 adds a combination (pair) consisting of the original target data subjected to the processing of loop L31, and the candidate value corresponding to the element with the lowest value, to the estimated value list (step S55). That is to say, the estimation unit 291 adds a combination consisting of the original target data subjected to the processing of loop L31 and the candidate value having the lowest non-applicability score, to the estimated value list.

Then, the control unit 290 performs termination processing of loop L31 (step S56). Specifically, the control unit 290 determines whether or not the processing of loop L31 has been performed for all original target data subjected to risk evaluation. If the control unit 290 determines that there is original target data that has not yet been subjected to the processing of loop L31, the processing returns to step S52, and the control unit 290 continues to perform the processing of loop L31 on the unprocessed original target data. On the other hand, if it is determined that the processing of loop L31 has been performed for all original target data subjected to risk evaluation, the control unit 290 terminates loop L31.

On the other hand, in step S54, if the estimation unit 291 determines that there are a plurality of elements with the lowest value (step S54: NO), the processing proceeds to step S56.

In step S56, if the control unit 290 has terminated loop L31, the risk evaluation device 200 ends the processing of FIG. 14.

The estimation unit 291 may further determine, in addition to there being only one element among the elements of the non-applicability score list with the lowest value, an estimated value of the classification item with the unknown value when a predetermined condition is met. For example, the estimation unit 291 may further determine, in addition to the number of elements among the elements of the non-applicability score list with the lowest value, whether or not to determine the estimated value based on the size of a difference between the lowest element value and the second lowest element value.

In addition to a case where there are a plurality of elements among the elements of the non-applicability score list with the lowest value, a case where the size of a difference between the lowest element value and the second lowest element value is small can be regarded as a situation in which the estimated value of the classification item with the unknown value cannot be estimated with a high accuracy. In this case, by not determining the estimated value of the classification item with the unknown value, the estimation unit 291 can indicate that the estimated value cannot be estimated with a high accuracy.

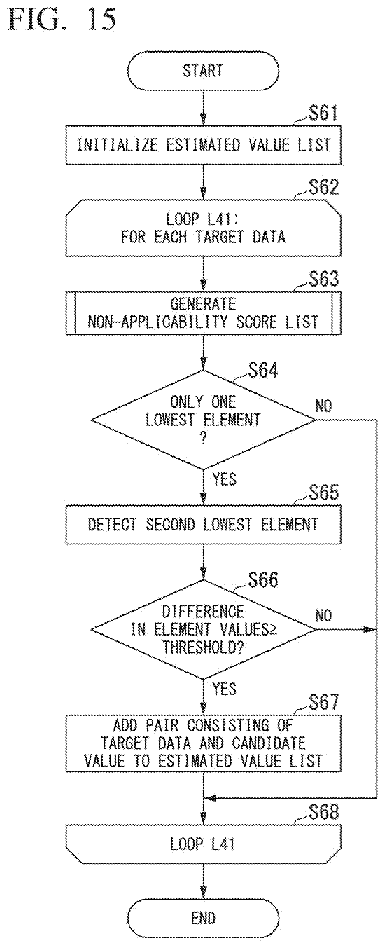

FIG. 15 is a diagram showing a fourth example of the processing procedure performed by the risk evaluation device 200 when an estimation unit 291 estimates the value of a classification item.

Step S61 in FIG. 15 is the same as step S51 in FIG. 14.

After step S61, the control unit 290 starts loop L41, which performs processing for each original target data (step S62).

Steps S63 and S64 in FIG. 15 are the same as steps S31 and S32 in FIG. 12.

In step S64, if it is determined that there is only one element with the lowest value (step S64: YES), the estimation unit 291 detects the second lowest element among the elements in the non-applicability score list (step S65).

Then, the estimation unit 291 determines whether or not the size of the difference in values between the element with the lowest value and the element with the second lowest value is greater than or equal to a predetermined threshold (step S66). This threshold is also referred to as a first threshold.

In step S66, if the estimation unit 291 determines that the size of the difference is greater than or equal to the first threshold (step S66: YES), the processing proceeds to step S67.

Step S67 in FIG. 15 is the same as step S55 in FIG. 14.

After step S67, the control unit 290 performs termination processing of loop L41 (step S68). Specifically, the control unit 290 determines whether or not the processing of loop L41 has been performed for all original target data subjected to risk evaluation. If the control unit 290 determines that there is original target data that has not yet been subjected to the processing of loop L41, the processing returns to step S62, and the control unit 290 continues to perform the processing of loop L41 on the unprocessed original target data. On the other hand, if it is determined that the processing of loop L41 has been performed for all original target data subjected to risk evaluation, the control unit 290 terminates the loop L41.

On the other hand, in step S64, if the estimation unit 291 determines that there are a plurality of elements with the lowest value (step S64: NO), the processing proceeds to step S68.

On the other hand, in step S66, if the estimation unit 291 determines that the size of the difference is smaller than the first threshold (step S66: NO), the processing proceeds to step S68.

In step S68, if the control unit 290 has terminated loop L41, the risk evaluation device 200 ends the processing of FIG. 15.

For example, even when an estimated value list is not generated, the estimation unit 291 may further determine, in addition to the number of elements among the elements of the non-applicability score list with the lowest value, whether or not to determine the estimated value based on the size of a difference between the lowest element value and the second lowest element value. If it is determined that the estimated value is not to be determined, the estimation unit 291 may set the estimated value to “None” as in step S44 of FIG. 13.

In addition, the estimation unit 291 may determine whether or not to determine an estimated value based on the magnitude of the lowest element value in the non-applicability score list.

A case where the lowest element value in the non-applicability score list is large can be regarded as a situation in which the estimated value of the classification item with the unknown value cannot be estimated with a high accuracy. In this case, by not determining an estimated value of the classification item with the unknown value, the estimation unit 291 can indicate that the estimated value cannot be estimated with a high accuracy.

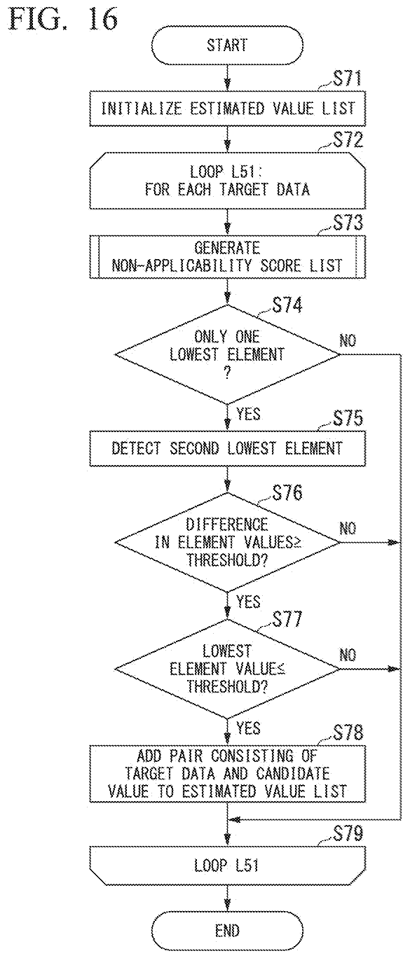

FIG. 16 is a diagram showing a fifth example of the processing procedure performed by the risk evaluation device 200 when an estimation unit 291 estimates the value of a classification item.

Step S71 in FIG. 16 is the same as step S51 in FIG. 14.

After step S71, the control unit 290 starts loop L51, which performs processing for each original target data (step S72).

Steps S73 to S76 in FIG. 16 are the same as steps S63 to S66 in FIG. 15.

In step S76, if it is determined that the size of the difference is greater than or equal to the first threshold (step S76: YES), the estimation unit 291 determines whether or not the lowest value of the elements in the non-applicability score list is less than or equal to a threshold (step S77). This threshold is also referred to as a second threshold.

If the estimation unit 291 determines that the lowest value is less than or equal to the second threshold (step S77: YES), the processing proceeds to step S78.

Step S78 in FIG. 16 is the same as step S55 in FIG. 14.

After step S78, the control unit 290 performs termination processing of loop L51 (step S79). Specifically, the control unit 290 determines whether or not the processing of loop L51 has been performed for all original target data subjected to risk evaluation. If the control unit 290 determines that there is original target data that has not yet been subjected to the processing of loop L51, the processing returns to step S72, and the control unit 290 continues to perform the processing of the loop L51 on the unprocessed original target data. On the other hand, if it is determined that the processing of the loop L51 has been performed for all original target data subjected to risk evaluation, the control unit 290 terminates loop L51.

On the other hand, in step S74, if the estimation unit 291 determines that there are a plurality of elements with the lowest value (step S74: NO), the processing proceeds to step S79.

On the other hand, in step S76, if the estimation unit 291 determines that the size of the difference is smaller than the first threshold (step S76: NO), the processing proceeds to step S79.

On the other hand, in step S77, if the estimation unit 291 determines that the lowest value is larger than the second threshold (step S77: NO), the processing proceeds to step S79.

In step S79, if the control unit 290 has terminated loop L51, the risk evaluation device 200 ends the processing of FIG. 16.

Even when an estimated value list is not generated, the estimation unit 291 may further determine, in addition to the number of elements among the elements of the non-applicability score list with the lowest value, and in addition to the size of the difference between the lowest element value and the second lowest element value, whether or not to determine the estimated value based on the size of the lowest element value. If it is determined that the estimated value is not to be determined, the estimation unit 291 may set the estimated value to “None” as in step S44 of FIG. 13.

The estimation unit 291 may determine whether or not to determine the estimated value based on the number of elements among the elements of the non-applicability score list with the lowest value, and the magnitude of the lowest element value. For example, in the processing of FIG. 16, the estimation unit 291 may perform the determination of step S77 after the processing of step S75, and not perform the determination of step S76.

Even when an estimated value list is not generated, the estimation unit 291 may determine whether or not to determine the estimated value based on the number of elements among the elements of the non-applicability score list with the lowest value, and the magnitude of the lowest element value. If it is determined that the estimated value is not to be determined, the estimation unit 291 may set the estimated value to “None” as in step S44 of FIG. 13.

In this way, as a result of the estimation unit 291 estimating the value of a classification item with an unknown value, the risk evaluation device 200 is capable of specifically presenting the data that has been determined to have a risk of leakage.

The estimation unit 291 may set, to the classification item of the original target data with an unknown value, the estimated value of the classification item. Then, the risk evaluation device 200 may output the target data set with the estimated value as data that has been determined to have a risk of leakage.

The risk evaluation device 200 may present the data that has been determined to have a risk of leakage, and data indicating the magnitude of the risk.

For example, the risk evaluation device 200 may output data in which the original target data, the estimated value of the target item, and the non-applicability score have been combined. Alternatively, the risk evaluation device 200 may output data as described above in which the target data set with the estimated value, and the non-applicability score have been combined.

As described above, the estimation unit 291 sets, among the candidate values included in a list of candidate values of a classification item with an unknown value, the candidate value having the lowest non-applicability score as the estimated value of the classification item.

According to the risk evaluation device 200, it is possible to specifically present data that has been determined to have a risk of leakage.

Furthermore, when there are a plurality of candidate values among the candidate values included in a list of candidate values of a classification item with an unknown value having the lowest non-applicability score, the estimation unit 291 may set the estimated value of the classification item as undetermined.

According to the risk evaluation device 200, it is possible to indicate that the estimated value of a classification item with an unknown value cannot be estimated with a high accuracy.

Moreover, the estimation unit 291 sets, when the size of a difference between the lowest value of the non-applicability scores and the next lowest value from the lowest value is smaller than the first threshold, the estimated value of the classification item as undetermined.

According to the risk evaluation device 200, it is possible to indicate that the estimated value of a classification item with an unknown value cannot be estimated with a high accuracy.

In addition, the estimation unit 291 sets, when the size of the lowest value of the non-applicability scores is larger than the second threshold, the estimated value of the classification item as undetermined.

According to the risk evaluation device 200, it is possible to indicate that the estimated value of a classification item with an unknown value cannot be estimated with a high accuracy.

Furthermore, the estimation unit 291 generates a list of pairs consisting of, among the plurality of target data in which the values of one or more classification items are unknown, target data in which the estimated values of the classification items with unknown values have been determined, and the estimated values.

According to the risk evaluation device 200, it is possible to display only the information for target data in which the estimation of the values of the classification items has succeeded, and in this respect, the amount of data that is output can be reduced.

### Third Example Embodiment

When a risk of information leakage is anticipated, a confidence score may be rewritten in order to reduce the risk of information leakage. This example aspect will be described in a third example embodiment.

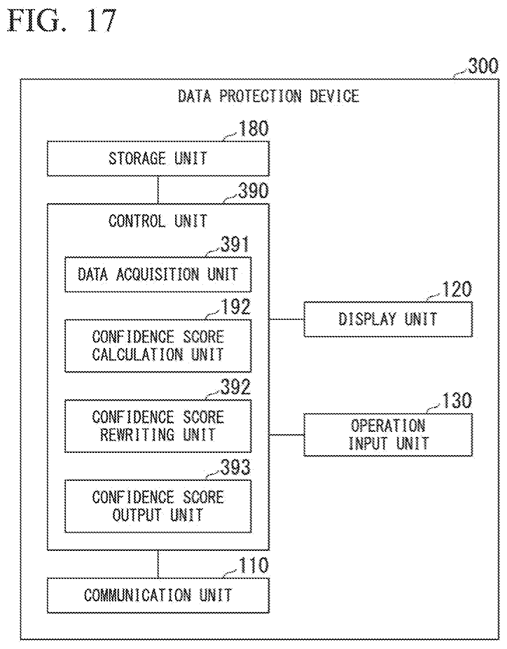

FIG. 17 is a diagram showing an example of a configuration of a data protection device according to the third example embodiment. In the configuration shown in FIG. 17, a data protection device 300 includes a communication unit 110, a display unit 120, an operation input unit 130, a storage unit 180, and a control unit 390. The control unit 390 includes a data acquisition unit 391, a confidence score calculation unit 192, a confidence score rewriting unit 392, and a confidence score output unit 393.

Of the units in FIG. 17, those units having the same functions as the units shown in FIG. 1 are designated by the same reference symbols (110, 120, 130, 180 and 192), and a detailed description will be omitted here. The data protection device 300 of FIG. 17 differs from the risk evaluation device 100 in that the control unit 390 does not include the risk evaluation unit 193 among the units provided in the control unit 190 in FIG. 1, and includes a confidence score rewriting unit 392 and a confidence score output unit 393. Furthermore, the data acquisition unit 391 acquires an explanatory variable value list. The data protection device 300 is the same as the risk evaluation device 100 in all other respects.

The data protection device 300 may be configured as a server device that receives an input of an explanatory variable value list, and outputs a confidence score list. A client device is capable of performing an estimation using a target model by acquiring the confidence score list from the data protection device 300.

The data acquisition unit 391 acquires an explanatory variable value list. For example, the data acquisition unit 391 receives an explanatory variable value list from another device via the communication unit 110.

The confidence score rewriting unit 392 rewrites, when the confidence score calculated by the confidence score calculation unit 192 indicates that the number of elements in the second set that are classified into a certain class is 0, the confidence score so as to indicate that the number of elements in the second set that are classified into the class is 1 or more.

For example, a case will be considered in which the confidence score calculation unit 192 reaches the node N131 in the partial model of FIG. 4, and calculates the confidence score list (1, 0). The fact that a confidence score, being an element of the confidence score list, is 0 indicates that the number of target data among the target data included in the data set DSUB that is classified into the node N131, and whose target variable value is “hot”, is 0.

Then, the confidence score rewriting unit 392 rewrites the confidence score that is 0. In addition, the confidence score rewriting unit 392 adjusts the values of the elements such that the sum of the elements of the confidence score list becomes 1. For example, the confidence score rewriting unit 392 rewrites the confidence score list (1, 0) to (0.8, 0.2).

The rewritten value used when the confidence score rewriting unit 392 rewrites the confidence score that is 0 is not limited to a specific value. For example, the confidence score rewriting unit 392 may randomly rewrite the confidence score that is 0 with a value in a predetermined range, such as a range from 0.1 to 0.4.

The confidence score output unit 393 outputs the rewritten confidence score. For example, the confidence score output unit 393 outputs the confidence score to another device via the communication unit 110.

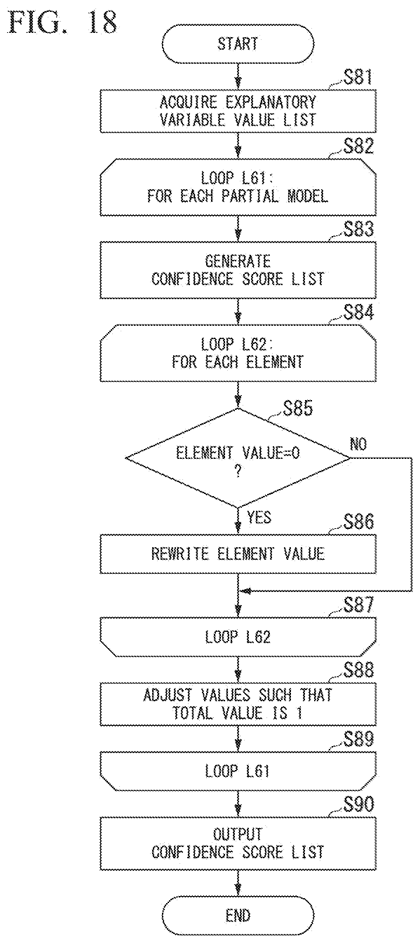

FIG. 18 is a diagram showing an example of the processing procedure performed when the data protection device 300 acquires an explanatory variable value list and outputs a confidence score.

In the processing of FIG. 18, the data acquisition unit 391 acquires an explanatory variable value list (step S81).

Then, the control unit 390 starts loop L61, which performs processing for each partial model (step S82).

In the processing of the loop L61, the confidence score calculation unit 192 generates a confidence score list (step S83). Specifically, the confidence score calculation unit 192 performs a first class classification by applying the partial model that is subjected to the processing of loop L61 to the explanatory variable value list obtained in step S81. Then, the confidence score calculation unit 192 acquires the classes that have been reached in the first class classification, and the number of data that have been classified into the classes, which is indicated for each class in the second class classification. The confidence score calculation unit 192 converts the obtained number for each class in the second class classification into a ratio of the number, and obtains a vector representing the converted ratios as a confidence score list. When converting the number to a ratio, the confidence score calculation unit 192 performs the conversion such that the sum of the ratios becomes 1.

Then, the control unit 390 starts loop L62, which performs processing for each element of the confidence score list obtained in step S83 (step S84).

In the processing of loop L62, the confidence score rewriting unit 392 determines whether or not the value of the element that is subjected to the processing of the loop L61 is 0 (step S85).

If it is determined that the value of the element is 0 (step S85: YES), the confidence score rewriting unit 392 rewrites the value of the element (step S86). As mentioned above, the rewritten value in this case is not limited to a specific value.

Then, the control unit 390 performs termination processing of loop L62 (step S87). Specifically, the control unit 390 determines whether or not the processing of loop L62 has been performed for all elements in the confidence score list obtained in step S83. If the control unit 390 determines that there is an element that has not yet been subjected to the processing of loop L62, the processing returns to step S84, and the control unit 390 continues to perform the processing of loop L62 on the unprocessed element. On the other hand, if it is determined that the processing of loop L62 has been performed for all elements of the confidence score list obtained in step S83, the control unit 390 terminates loop L62.

On the other hand, in step S85, if the controller 390 determines that the value of the element is not 0 (step S85: NO) the processing proceeds to step S87.

If the control unit 390 has terminated loop L62 in step S87, the confidence score rewriting unit 392 rewrites the values of the elements of the confidence score list such that the sum of the elements becomes 1 (step S88).

Then, the control unit 390 performs termination processing of loop L61 (step S89). Specifically, the control unit 390 determines whether or not the processing of loop L61 has been performed for all partial models of the target model. If the control unit 390 determines that there is a partial model that has not yet been subjected to the processing of loop L61, the processing returns to step S82, and the control unit 390 continues to perform the processing of the loop L61 on the unprocessed partial model. On the other hand, if it is determined that the processing of loop L61 has been performed for all of the partial models of the target model, the control unit 390 terminates loop L61.

When the control unit 390 has terminated loop L61 in step S89, the confidence score output unit 393 outputs the confidence score list of each partial model (step S90).

After step S90, the data protection device 300 ends the processing of FIG. 18.

It is also possible to achieve a reduction in the risk of information leakage as a result of the data protection device 300 rewriting the target model in addition to, or instead of, rewriting the confidence score.

For example, the data protection device 300 may rewrite data indicating that the number of elements among the elements of the data set DSUB that are classified into a corresponding class is 0, with data indicating that the number of elements is 1 or more. In the case of the example of FIG. 4, the data protection device 300 may rewrite the “0 people” for “hot” in the node N131 with “1 person”.

Alternatively, the target model may indicate a confidence score instead of the number of data. In this case, the data protection device 300 may rewrite a confidence score of 0 indicated in the target model, with a value larger than 0.

As described above, the data acquisition unit 391 acquires an explanatory variable value list. The explanatory variable value list is a list of values of classification items representing items used to perform a first class classification.

The confidence score calculation unit 192 calculates confidence scores for each partial model of the target model. The target model is a model including, for each class in a class classification performed using a combination of a first class classification and a second class classification, partial models indicating the degree to which the elements of the data set DSUB are classified into the class for each of the plurality of ways of performing the first class classification. The data set DSUB is a set that is generated from the data set D for each partial model. The confidence score indicates the degree to which an element of the data set DSUB is classified into a class that is classified in the first class classification with respect to the explanatory variable value list, and a class in the second class classification.

The confidence score rewriting unit 392 rewrites, when the confidence score indicates that the number of elements in the data set DSUB that are classified into a certain class is 0, the confidence score so as to indicate that the number of elements in the data set DSUB that are classified into the class is 1 or more.

The confidence score output unit 393 outputs the rewritten confidence score.

According to the data protection device 300, it is possible to evaluate the risk of leakage of the data included in the data set D based on a confidence score, and the risk of data leakage can be reduced.

Furthermore, a partial model of a target model is a decision tree representing the first class classification by branching. According to the data protection device 300, a class classification can be performed by the relatively simple processing of following the conditions shown in the root and the intermediate nodes from the root to a leaf.

Furthermore, a partial model of a target model indicates, for each class in a class classification performed using a combination of a first class classification and a second class classification, the number of elements among the elements of the data set DSUB that are classified into that class. The confidence score calculation unit 192 calculates a confidence score, which indicates, for a single class in the first class classification, a ratio of a number of elements among the elements of the data set DSUB that are classified into each class of the second class classification. According to the data protection device 300, when performing an estimation using a target model, it is possible to determine an estimated value using a confidence score.

Alternatively, the data protection device 300 may specify, for a machine learning model including a plurality of partial models, the data in each of the partial models having a vulnerability to a membership inference attack, and then generate data in which the specified data has been merged, and output, for the generated data, a score having a different value to a score calculated by the plurality of partial models. The specification of the data having a vulnerability in this case corresponds to an example of evaluating a risk of a data leakage. Furthermore, outputting a score having a value that is different from a score that is calculated by a plurality of partial models corresponds to an example of reducing the risk of a data leakage. In this way, according to the data protection device 300, it is possible to evaluate the risk of a data leakage, and the risk of data leakage can be reduced.

### Fourth Example Embodiment

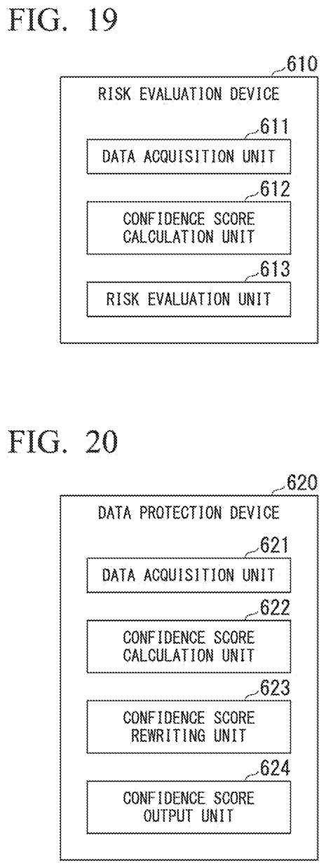

FIG. 19 is a diagram showing an example of a configuration of a risk evaluation device according to a fourth example embodiment. In the configuration shown in FIG. 19, the risk evaluation device 610 includes a data acquisition unit 611, a confidence score calculation unit 612, and a risk evaluation unit 613.

In such a configuration, the data acquisition unit 611 acquires target data, which includes an explanatory variable value list, being a list of values of classification items representing items used in a first class classification, and a target variable value, being a value that identifies a class in a second class classification.

The confidence score calculation unit 612 calculates a confidence score for each class in a class classification performed using a combination of a first class classification and a second class classification that indicates, for each partial model of a model that includes each of a plurality of ways of performing the first class classification, the partial model indicating a degree to which an element of a second set that has been generated for each partial model from a predetermined first set is classified into that class, a degree to which the element of the second set is classified into a class in the first class classification, which is performed with respect to the explanatory variable value list included in the target data, and a class in the second class classification, which is identified by the target variable value included in the target data.

The risk evaluation unit 613 evaluates a possibility that the target data is included in the first set based on the confidence score of each partial model.

The data acquisition unit 611 corresponds to an example of a data acquisition means. The confidence score calculation unit 612 corresponds to an example of a confidence score calculation means. The risk evaluation unit 613 corresponds to an example of a risk evaluation means.

According to the risk evaluation device 610, it is possible to evaluate the possibility that the target data obtained using a model, is included in the first set. According to the risk evaluation device 610, in this respect, it is possible to evaluate the risk of information leakage when a model including a plurality of partial models is used.

The data acquisition unit 611 can be realized, for example, using the functions of the data acquisition unit 191 in FIG. 1 and the like. The confidence score calculation unit 612 can be realized, for example, using the functions of the confidence score calculation unit 192 in FIG. 1 and the like. The risk evaluation unit 613 can, for example, be realized using the functions of the risk evaluation unit 193 in FIG. 1 and the like.

### Fifth Example Embodiment

FIG. 20 is a diagram showing an example of a configuration of a data protection device according to a fifth example embodiment. In the configuration shown in FIG. 20, a data protection device 620 includes a data acquisition unit 621, a confidence score calculation unit 622, a confidence score rewriting unit 623, and a confidence score output unit 624.

In such a configuration, the data acquisition unit 621 acquires an explanatory variable value list, being a list of values of classification items representing items used in a first class classification.

The confidence score calculation unit 622 calculates a confidence score for each class in a class classification performed using a combination of a first class classification and a second class classification that indicates, for each partial model of a model that includes each of a plurality of ways of performing the first class classification, the partial model indicating a degree to which an element of a second set that has been generated for each partial model from a predetermined first set is classified into that class, a degree to which the element of the second set is classified into a class in the first class classification, which is performed with respect to the explanatory variable value list, and a class in the second class classification.

The confidence score rewriting unit 623 rewrites, when the confidence score indicates that the number of elements in the second set that are classified into a certain class is 0, the confidence score so as to indicate that the number of elements in the second set that are classified into the class is 1 or more.

The confidence score output unit 624 outputs the rewritten confidence score.

The data acquisition unit 621 corresponds to an example of a data acquisition means. The confidence score calculation unit 622 corresponds to an example of a confidence score calculation means. The confidence score rewriting unit 623 corresponds to an example of a confidence score rewriting means. The confidence score output unit 624 corresponds to an example of a confidence score output means.

According to the data protection device 620, it is possible to evaluate the risk of leakage of the data included in the first set based on a confidence score, and the risk of data leakage can be reduced.

The data acquisition unit 621 can be realized, for example, using the functions of the data acquisition unit 391 in FIG. 17 and the like. The confidence score calculation unit 622 can be realized, for example, using the functions of the confidence score calculation unit 192 in FIG. 17 and the like. The confidence score rewriting unit 623 can be realized, for example, using the functions of the confidence score rewriting unit 392 in FIG. 17 and the like. The confidence score output unit 624 can be realized, for example, using the functions of the confidence score output unit 393 in FIG. 17 and the like.

### Sixth Example Embodiment

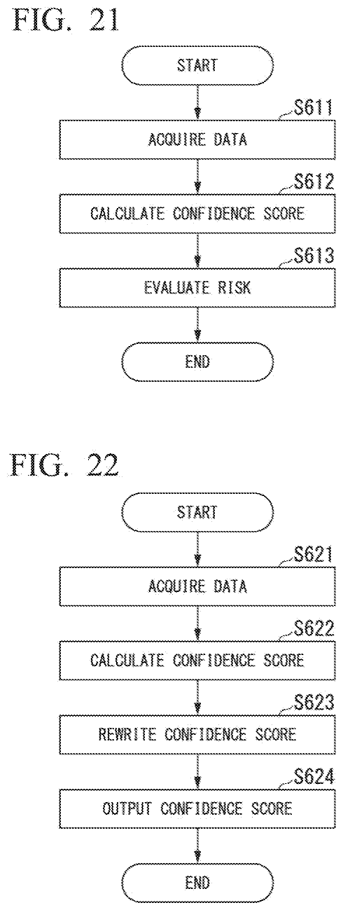

FIG. 21 is a diagram showing an example of the processing procedure of a risk evaluation method according to a sixth example embodiment. The risk evaluation method shown in FIG. 21 includes the steps of: acquiring data (step S611); calculating a confidence score (step S612); and calculating a risk (step S613).

In the step of acquiring data (step S611) a computer acquires target data, which includes an explanatory variable value list, being a list of values of classification items representing items used in a first class classification, and a target variable value, being a value that identifies a class in a second class classification.

In the step of calculating a confidence score (step S612), a computer calculates a confidence score for each class in a class classification performed using a combination of the first class classification and the second class classification that indicates, for each partial model of a model that includes each of a plurality of ways of performing the first class classification, the partial model indicating a degree to which an element of a second set that has been generated for each partial model from a predetermined first set is classified into that class, a degree to which the element of the second set is classified into a class in the first class classification, which is performed with respect to the explanatory variable value list included in the target data, and a class in the second class classification, which is identified by the target variable value included in the target data.

In the step of evaluating a risk (step S613), a computer evaluates a possibility that the target data is included in the first set based on the confidence score of each partial model.

According to the risk evaluation method shown in FIG. 21, it is possible to evaluate the possibility that the target data obtained using a model, is included in the first set. According to the risk evaluation method shown in FIG. 21, in this respect, it is possible to evaluate the risk of information leakage when a model including a plurality of partial models is used.

### Seventh Example Embodiment

FIG. 22 is a diagram showing an example of the processing procedure of a data protection method according to a seventh example embodiment. The data protection method shown in FIG. 22 includes the steps of acquiring data (step S621); calculating a confidence score (step S622); rewriting a confidence score (step S623); and outputting a confidence score (step S624).

In the step of acquiring data (step S621), a computer acquires an explanatory variable value list, being a list of values of classification items representing items used in a first class classification.

In the step of calculating a confidence score (step S622), a computer calculates a confidence score for each class in a class classification performed using a combination of the first class classification and the second class classification that indicates, for each partial model of a model that includes each of a plurality of ways of performing the first class classification, the partial model indicating a degree to which an element of a second set that has been generated for each partial model from a predetermined first set is classified into that class, a degree to which the element of the second set is classified into a class in the first class classification, which is performed with respect to the explanatory variable value list, and a class in the second class classification.

In the step of rewriting a confidence score (step S623), a computer rewrites, when the confidence score indicates that a number of elements in the second set that are classified into a certain class is 0, the confidence score so as to indicate that a number of elements in the second set that are classified into that class is 1 or more.

In the step of outputting a confidence score (step S624), a computer outputs a rewritten confidence score.

According to the data protection method shown in FIG. 22, it is possible to evaluate the risk of leakage of the data included in the first set based on a confidence score, and the risk of data leakage can be reduced.

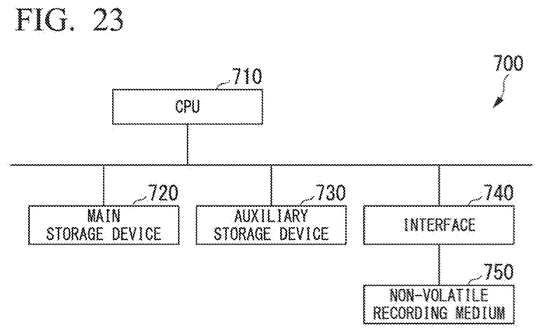

FIG. 23 is a schematic block diagram showing a configuration of a computer according to at least one example embodiment.

In the configuration shown in FIG. 23, a computer 700 includes a CPU 710, a main storage device 720, an auxiliary storage device 730, an interface 740, and a non-volatile recording medium 750.

Any one or more of the risk evaluation device 100, the risk evaluation device 200, the data protection device 300, the risk evaluation device 610, and the data protection device 620, or a portion thereof, may be implemented by the computer 700. In this case, the operation of each of the processing units described above is stored in the auxiliary storage device 730 in the form of a program. The CPU 710 reads the program from the auxiliary storage device 730, expands the program in the main storage device 720, and executes the processing described above according to the program. Further, the CPU 710 secures a storage area corresponding to each of the storage units in the main storage device 720 according to the program. The communication of each device with other devices is executed as a result of the interface 740 having a communication function and performing communication according to the control of the CPU 710. Furthermore, the interface 740 includes a port for the non-volatile recording medium 750, and reads information from the non-volatile recording medium 750 and writes information to the non-volatile recording medium 750.

When the risk evaluation device 100 is implemented by the computer 700, the operation of the control unit 190 and each of the units thereof is stored in the auxiliary storage device 730 in the form of a program. The CPU 710 reads the program from the auxiliary storage device 730, expands the program in the main storage device 720, and executes the processing described above according to the program.

Furthermore, the CPU 710 secures a storage area for the storage unit 180 in the main storage device 720 according to the program. The communication by the communication unit 110 with other devices is executed as a result of the interface 740 including a communication function and operating under the control of the CPU 710. The display of images by the display unit 120 is executed as a result of the interface 740 including a display device, and displaying various images under the control of the CPU 710. The reception of user operations by the operation input unit 130 is executed as a result of the interface 740 including an input device, and receiving user operations under the control of the CPU 710.

When the risk evaluation device 200 is implemented by the computer 700, the operation of the control unit 290 and each of the units thereof is stored in the auxiliary storage device 730 in the form of a program. The CPU 710 reads the program from the auxiliary storage device 730, expands the program in the main storage device 720, and executes the processing described above according to the program.

Furthermore, the CPU 710 secures a storage area for the storage unit 180 in the main storage device 720 according to the program. The communication by the communication unit 110 with other devices is executed as a result of the interface 740 including a communication function and operating under the control of the CPU 710. The display of images by the display unit 120 is executed as a result of the interface 740 including a display device, and displaying various images under the control of the CPU 710. The reception of user operations by the operation input unit 130 is executed as a result of the interface 740 including an input device, and receiving user operations under the control of the CPU 710.

When the data protection device 300 is implemented by the computer 700, the operation of the control unit 390 and each of the units thereof is stored in the auxiliary storage device 730 in the form of a program. The CPU 710 reads the program from the auxiliary storage device 730, expands the program in the main storage device 720, and executes the processing described above according to the program.

Furthermore, the CPU 710 secures a storage area for the storage unit 180 in the main storage device 720 according to the program. The communication by the communication unit 110 with other devices is executed as a result of the interface 740 including a communication function and operating under the control of the CPU 710. The display of images by the display unit 120 is executed as a result of the interface 740 including a display device, and displaying various images under the control of the CPU 710. The reception of user operations by the operation input unit 130 is executed as a result of the interface 740 including an input device, and receiving user operations under the control of the CPU 710.

When the risk evaluation device 610 is implemented by the computer 700, the operation of the data acquisition unit 611, the confidence score calculation unit 612, and the risk evaluation unit 613 is stored in the auxiliary storage device 730 in the form of a program. The CPU 710 reads the program from the auxiliary storage device 730, expands the program in the main storage device 720, and executes the processing described above according to the program.

Furthermore, the CPU 710 secures a storage area in the main storage device 720 for the risk evaluation device 610 to perform processing according to the program. The communication between the risk evaluation device 610 and other devices is executed as a result of the interface 740 including a communication function and operating under the control of the CPU 710. The interactions between the risk evaluation device 610 and the user is executed as a result of the interface 740 having an input device and an output device, presenting information to the user through the output device under the control of the CPU 710, and receiving user operations through the input device.

When the data protection device 620 is implemented by the computer 700, the operation of the data acquisition unit 621, the confidence score calculation unit 622, the confidence score rewriting unit 623, and the confidence score output unit 624 is stored in the auxiliary storage device 730 in the form of a program. The CPU 710 reads the program from the auxiliary storage device 730, expands the program in the main storage device 720, and executes the processing described above according to the program.

Furthermore, the CPU 710 secures a storage area in the main storage device 720 for the data protection device 620 to perform processing according to the program. The communication between the data protection device 620 and other devices is executed as a result of the interface 740 including a communication function and operating under the control of the CPU 710. The interactions between the data protection device 620 and the user is executed as a result of the interface 740 having an input device and an output device, presenting information to the user through the output device under the control of the CPU 710, and receiving user operations through the input device.

One or more of the programs described above may be recorded in the non-volatile recording medium 750. In this case, the interface 740 may read out the program from the non-volatile recording medium 750. Then, the CPU 710 directly executes the program that has been read out by the interface 740, or executes the program after temporarily saving it in the main storage device 720 or the auxiliary storage device 730.

A program for executing some or all of the processing performed by the risk evaluation device 100, the risk evaluation device 200, the data protection device 300, the risk evaluation device 610, and the data protection device 620 may be recorded in a computer-readable recording medium, and the processing of each unit may be performed by a computer system reading and executing the program recorded on the recording medium. The “computer system” referred to here is assumed to include an OS (operating system) and hardware such as a peripheral device.

Furthermore, the “computer-readable recording medium” refers to a portable medium such as a flexible disk, a magnetic optical disk, a ROM (read-only memory), or a CD-ROM (compact disc read-only memory), or a storage device such as a hard disk built into a computer system. Moreover, the program may be one capable of realizing some of the functions described above. Further, the functions described above may be realized in combination with a program already recorded in the computer system.

Example embodiments of the present disclosure have been described in detail above with reference to the drawings. However, specific configurations are in no way limited to the example embodiments, and include designs and the like within a scope not departing from the spirit of the present disclosure.

The whole or part of the example embodiments above can be described as the supplementary notes below, but the embodiment is not limited thereto.

While preferred embodiments of the disclosure have been described and illustrated above, it should be understood that these are example of the disclosure and are not to be considered as limiting. Additions, omissions, substitutions, and other modifications can be made without departing from the scope of the present disclosure. Accordingly, the disclosure is not to be considered as being limited by the foregoing description, and is only limited by the scope of the appended claims

### (Supplementary Note 1)

A risk evaluation device comprising:
a data acquisition means that acquires target data, which includes an explanatory variable value list, being a list of values of classification items representing items used in a first class classification, and a target variable value, being a value that identifies a class in a second class classification;
a confidence score calculation means that calculates a confidence score for each class in a class classification performed using a combination of the first class classification and the second class classification that indicates, for each partial model of a model that includes each of a plurality of ways of performing the first class classification, the partial model indicating a degree to which an element of a second set that has been generated for each partial model from a predetermined first set is classified into the class, a degree to which the element of the second set is classified into a class in the first class classification, which is performed with respect to the explanatory variable value list included in the target data, and a class in the second class classification, which is identified by the target variable value included in the target data; and
a risk evaluation means that evaluates a possibility that the target data is included in the first set based on the confidence score of each partial model.

### (Supplementary Note 2)

The risk evaluation device according to supplementary note 1, wherein
the partial model is a decision tree representing the first class classification by branching.

### (Supplementary Note 3)

The risk evaluation device according to supplementary note 1 or 2, wherein
the partial model represents for each class in a class classification performed using a combination of the first class classification and the second class classification, a number of elements among elements of the second set that are classified into the class, and
the confidence score calculation means calculates the confidence score, which indicates, for a single class in the first class classification, a ratio of a number of elements among elements of the second set that are classified into each class of the second class classification.

### (Supplementary Note 4)

The risk evaluation device according to any one of supplementary notes 1 to 3, wherein
the data acquisition means generates target data subjected to calculation of the confidence score by setting, to target data in which values of one or more classification items are unknown, candidate values of a classification item with an unknown value.

### (Supplementary Note 5)

The risk evaluation device according to supplementary note 4, wherein
the risk evaluation means calculates, for each candidate value included in a list of candidate values of classification items with an unknown value, a non-applicability score that indicates, for target data in which the candidate value has been set, a number of partial models indicating that there are no elements among elements of the second set that are classified into a class that has been classified in the first class classification, which is performed with respect to the explanatory variable value list included in the target data, and a class of the second class classification, which is identified by the target variable value included in the target data.

### (Supplementary Note 6)

The risk evaluation device according to supplementary note 5, further comprising
an estimation means that sets, among candidate values included in a list of candidate values of a classification item with an unknown value, a candidate value having a lowest non-applicability score, as an estimated value of the classification item.

### (Supplementary Note 7)

The risk evaluation device according to supplementary note 6, wherein
the estimation means sets, among candidate values included in a list of candidate values of a classification item with an unknown value, an estimated value of the classification item as undetermined when there are a plurality of candidate values having a lowest non-applicability score.

### (Supplementary Note 8)

The risk evaluation device according to supplementary note 7, wherein
the estimation means sets, when a size of a difference between a lowest value of the non-applicability scores and a next lowest value after a lowest value is smaller than a predetermined threshold, an estimated value of the classification item as undetermined.

### (Supplementary Note 9)

The risk evaluation device according to supplementary notes 7 or 8, wherein
the estimation means sets, when a lowest value of the non-applicability scores is larger than a predetermined threshold, an estimated value of the classification item as undetermined.

### (Supplementary Note 10)

The risk evaluation device according to any one of supplementary notes 7 to 9, wherein
the estimation means generates a list of pairs consisting of, among the plurality of target data in which the values of one or more classification item are unknown, target data in which the estimated values of the classification items with unknown values have been determined, and the estimated values.

### (Supplementary Note 11)

A data protection device that
specifies, for a machine learning model including a plurality of partial models, data in each of the partial models having a vulnerability to a membership inference attack,
generates data in which the specified data has been merged, and
outputs, for the generated data, a score having a different value to a score calculated by the plurality of partial models.

### (Supplementary Note 12)

A data protection device comprising:
a data acquisition means that acquires an explanatory variable value list, being a list of values of classification items representing items used in a first class classification;
a confidence score calculation means that calculates a confidence score for each class in a class classification performed using a combination of the first class classification and the second class classification that indicates, for each partial model of a model that includes each of a plurality of ways of performing the first class classification, the partial model indicating a degree to which an element of a second set that has been generated for each partial model from a predetermined first set is classified into the class, a degree to which the element of the second set is classified into a class in the first class classification, which is performed with respect to the explanatory variable value list, and a class in the second class classification;
a confidence score rewriting means that, when the confidence score indicates that a number of elements in the second set that are classified into a certain class is 0, rewrites said confidence score so as to indicate that a number of elements in the second set that are classified into the class is 1 or more; and
a confidence score output means that outputs a rewritten confidence score.

### (Supplementary Note 13)

The data protection device according to supplementary note 12, wherein
the partial model is a decision tree representing the first class classification by branching.

### (Supplementary Note 14)

The data protection device according to supplementary note 12 or 13, wherein
the partial model represents for each class in a class classification performed using a combination of the first class classification and the second class classification, a number of elements among elements of the second set that are classified into the class, and
the confidence score calculation means calculates the confidence score, which indicates, for a single class in the first class classification, a ratio of a number of elements among elements of the second set that are classified into each class of the second class classification.

### (Supplementary Note 15)

A risk evaluation method, in which a computer performs the steps of:
acquiring target data, which includes an explanatory variable value list, being a list of values of classification items representing items used in a first class classification, and a target variable value, being a value that identifies a class in a second class classification;
calculating a confidence score for each class in a class classification performed using a combination of the first class classification and the second class classification that indicates, for each partial model of a model that includes each of a plurality of ways of performing the first class classification, the partial model indicating a degree to which an element of a second set that has been generated for each partial model from a predetermined first set is classified into the class, a degree to which the element of the second set is classified into a class in the first class classification, which is performed with respect to the explanatory variable value list included in the target data, and a class in the second class classification, which is identified by the target variable value included in the target data; and
evaluating a possibility that the target data is included in the first set based on the confidence score of each partial model.

### (Supplementary Note 16)

A data protection method, in which a computer executes the steps of:
specifying, for a machine learning model including a plurality of partial models, data in each of the partial models having a vulnerability to a membership inference attack;
generating data in which the specified data has been merged; and
outputting, for the generated data, a score having a different value to a score calculated by the plurality of partial models.

### (Supplementary Note 17)

A data protection method, in which a computer executes the steps of:
acquiring an explanatory variable value list, being a list of values of classification items representing items used in a first class classification;
calculating a confidence score for each class in a class classification performed using a combination of the first class classification and the second class classification that indicates, for each partial model of a model that includes each of a plurality of ways of performing the first class classification, the partial model indicating a degree to which an element of a second set that has been generated for each partial model from a predetermined first set is classified into the class, a degree to which the element of the second set is classified into a class in the first class classification, which is performed with respect to the explanatory variable value list, and a class in the second class classification;
rewriting, when the confidence score indicates that a number of elements in the second set that are classified into a certain class is 0, the confidence score so as to indicate that a number of elements in the second set that are classified into the class is 1 or more; and
outputting a rewritten confidence score.

### (Supplementary Note 18)

A program that causes a computer to execute the steps of:
specifying, for a machine learning model including a plurality of partial models, data in each of the partial models having a vulnerability to a membership inference attack;
generating data in which the specified data has been merged; and
outputting, for the generated data, a score having a different value to a score calculated by the plurality of partial models.

### (Supplementary Note 19)

A program that causes a computer to execute the steps of:
acquiring target data, which includes an explanatory variable value list, being a list of values of classification items representing items used in a first class classification, and a target variable value, being a value that identifies a class in a second class classification;
calculating a confidence score for each class in a class classification performed using a combination of the first class classification and the second class classification that indicates, for each partial model of a model that includes each of a plurality of ways of performing the first class classification, the partial model indicating a degree to which an element of a second set that has been generated for each partial model from a predetermined first set is classified into the class, a degree to which the element of the second set is classified into a class in the first class classification, which is performed with respect to the explanatory variable value list included in the target data, and a class in the second class classification, which is identified by the target variable value included in the target data; and
evaluating a possibility that the target data is included in the first set based on the confidence score of each partial model.

### (Supplementary Note 20)

A program that causes a computer to execute the steps of:
acquiring an explanatory variable value list, being a list of values of classification items representing items used in a first class classification;
calculating a confidence score for each class in a class classification performed using a combination of the first class classification and the second class classification that indicates, for each partial model of a model that includes each of a plurality of ways of performing the first class classification, the partial model indicating a degree to which an element of a second set that has been generated for each partial model from a predetermined first set is classified into the class, a degree to which the element of the second set is classified into a class in the first class classification, which is performed with respect to the explanatory variable value list, and a class in the second class classification;
rewriting, when the confidence score indicates that a number of elements in the second set that are classified into a certain class is 0, the confidence score so as to indicate that a number of elements in the second set that are classified into the class is 1 or more; and
outputting a rewritten confidence score.

What is claimed is:

1. A risk evaluation device comprising:
at least one memory configured to store instructions; and
at least one processor configured to execute the instructions to:
acquire target data including an explanatory variable value list and a target variable value, wherein the explanatory variable value list is a list of values of classification items representing items used in a first class classification, and the target variable value is a value that identifies a class in a second class classification;
calculate a confidence score for each partial model of a target model, wherein the target model includes the partial model for each of a plurality of ways of performing the first class classification, wherein the partial model indicates, for each class in a class classification performed using a combination of the first class classification and the second class classification, a degree to which an element of a second set generated for each partial model from a predetermined first set is classified into the class, and wherein the confidence score indicates a degree to which the element of the second set is classified into a class in the first class classification, which is performed with respect to the explanatory variable value list included in the target data, and a class in the second classification, which is identified by the target variable value included in the target data; and
evaluate a possibility that the target data is included in the first set based on the confidence score of each partial model.

2. The risk evaluation device according to claim 1, wherein the partial model is a decision tree representing the first class classification by branching.

3. The risk evaluation device according to claim 1, wherein the partial model represents for each class in a class classification performed using a combination of the first class classification and the second class classification, a number of elements among elements of the second set that are classified into said class, and
wherein the at least one processor is configured to execute the instructions to calculate the confidence score, which indicates, for a single class in the first class classification, a ratio of a number of elements among elements of the second set that are classified into each class of the second class classification.

4. The risk evaluation device according to claim 1, wherein the at least one processor is configured to execute the instructions to generate target data subjected to calculation of the confidence score by setting, to target data in which values of one or more classification items are unknown, candidate values of a classification item with an unknown value.

5. The risk evaluation device according to claim 4, wherein the at least one processor is configured to execute the instructions to calculate, for each candidate value included in a list of candidate values of classification items with an unknown value, a non-applicability score that indicates, for target data in which the candidate value has been set, a number of partial models indicating that there are no elements among elements of the second set that are classified into a class that has been classified in the first class classification, which is performed with respect to the explanatory variable value list included in the target data, and a class of the second class classification, which is identified by the target variable value included in the target data.

6. The risk evaluation device according to claim 5, wherein the at least one processor is configured to execute the instructions to set, among candidate values included in a list of candidate values of a classification item with an unknown value, a candidate value having a lowest non-applicability score, as an estimated value of the classification item.

7. The risk evaluation device according to claim 6, wherein the at least one processor is configured to execute the instructions to set, among candidate values included in a list of candidate values of a classification item with an unknown value, an estimated value of the classification item as undetermined in a case where there are a plurality of candidate values having a lowest non-applicability score.

8. The risk evaluation device according to claim 6, wherein the at least one processor is configured to execute the instructions to set, in a case where a size of a difference between a lowest value of the non-applicability scores and a next lowest value after a lowest value is smaller than a predetermined threshold, an estimated value of the classification item as undetermined.

9. The risk evaluation device according to claim 7, wherein the at least one processor is configured to execute the instructions to set, in a case where a lowest value of the non-applicability scores is larger than a predetermined threshold, an estimated value of the classification item as undetermined.

10. The risk evaluation device according to claim 7, wherein the at least one processor is configured to execute the instructions to generate a list of pairs including, among the plurality of target data in which the values of one or more classification item are unknown, target data in which the estimated values of the classification items with unknown values have been determined, and the estimated values.

11. A data protection device comprising:
at least one memory configured to store instructions; and
at least one processor configured to execute the instructions to:
specify, for a machine learning model including a plurality of partial models, data in each of the partial models having a vulnerability to a membership inference attack;
generate data in which the specified data has been merged; and
output, for the generated data, a score having a different value to a score calculated by the plurality of partial models.

12. A risk evaluation method executed by a computer, the method comprising:
acquiring target data including an explanatory variable value list and a target variable value, wherein the explanatory variable value list is a list of values of classification items representing items used in a first class classification, and the target variable value is a value that identifies a class in a second class classification;
calculating a confidence score for each partial model of a target model, wherein the target model includes the partial model for each of a plurality of ways of performing the first class classification, wherein the partial model indicates, for each class in a class classification performed using a combination of the first class classification and the second class classification, a degree to which an element of a second set generated for each partial model from a predetermined first set is classified into the class, and wherein the confidence score indicates a degree to which the element of the second set is classified into a class in the first class classification, which is performed with respect to the explanatory variable value list included in the target data, and a class in the second classification, which is identified by the target variable value included in the target data; and
evaluating a possibility that the target data is included in the first set based on the confidence score of each partial model.
